(19) United States
(12) Patent Application Publication
(10) Pub. No.: US 2026/0140260 A1
(43) Pub. Date: May 21, 2026

(54) POTENTIAL OBJECT PATHWAY DETERMINATION METHOD, APPARATUS AND SYSTEM

(71) Applicant: NEC Corporation, Minato-ku, Tokyo (JP)

(72) Inventors: Masafumi WATANABE, Singapore (SG); Boon choon YEO, Singapore (SG); Ling Peow HO, Singapore (SG)

(73) Assignee: NEC Corporation, Minato-ku, Tokyo (JP)

(21) Appl. No.: 18/704,136

(22) PCT Filed: Mar. 16, 2023
(86) PCT No.: PCT/JP2023/010481

§ 371 Date: Apr. 24, 2024

(30) Foreign Application Priority Data
Mar. 30, 2022 (SG) 10202203271V

(51) Int. Cl. G01S 17/66; G01S 17/89

(52) U.S. Cl. CPC G01S 17/66; G01S 17/89

(57) ABSTRACT

The present disclosure provides a method, an apparatus and a system for determining a potential pathway of an object. The potential object pathway determination method comprises: determining, if a first location at which a first object is detected at a detection time along a first pathway of the first object is within a ground distance from a second location at which a second object is detected at or after the detection time along a second pathway of the second object; and joining at least a part of the first pathway detected before the detection time, at least one of the first location and the second location, and at least a part of the second pathway detected after the detection time to form a continuous potential pathway of the first object in response to the determination of the first location being within the ground distance from the second location.

### TECHNICAL FIELD

The present disclosure relates to an object pathway detection or determination method, apparatus and system, and more particularly, relates to a method, an apparatus and a system for determining a potential pathway of an object.

### BACKGROUND ART

There are increasing needs to perform high-resolution tracking of people for different reasons, for example, monitoring patients wandering in the wards, understanding shoppers'movement patterns within the mall and tracking a person of interest for law enforcement and safety purpose. Among all methods employed today, one method is the use of facial recognition (FR) through video cameras, but as this method requires many cameras to be deployed to achieve fine-grained tracking.

### SUMMARY OF INVENTION

### Technical Problem

Usage of multiple modes of sensors, which combines usage of a camera for FR and a different mode of sensor such as Wi-Fi and LiDAR (light detection and ranging), are increasingly popular to achieve fine-grained tracking. However, some sensors such as LiDAR only works well when there is line-of-sight from the sensors to the object being tracked but does not work well and accurately when there are occlusions caused by another object coming in between. The tracking of an object may be disrupted when occlusions happen or when two or more objects are too close to each other, the sensors may become confused and mix up or lose the track of the object.

There is thus a need to develop a method, apparatus and system for determining a potential pathway of an object to address the above-mentioned issues and limitations of multi-modal sensing technique/system combining FR and a fine-grained object tracking method such as LiDAR sensing to achieve high-resolution tracking over a wide area, i.e., across multiple cameras/sensors, within or lack of line-of-sight conditions.

Furthermore, other desirable features and characteristics will become apparent from the subsequent detailed description and the appended claims, taken in conjunction with the accompanying drawings and this background of the disclosure.

### Solution to Problem

In a first aspect, the present disclosure provides a method for determining a potential pathway of an object, the pathway of the object comprising a plurality of locations at which the object is detected at a corresponding plurality of detection times, the method comprising: determining, if a first location at which a first object is detected at a detection time along a first pathway of the first object is within a ground distance from a second location at which a second object is detected at or after the detection time along a second pathway of the second object; and joining at least a part of the first pathway detected before the detection time, at least one of the first location and the second location, and at least a part of the second pathway detected after the detection time to form a continuous potential pathway of the first object in response to the determination of the first location being within the ground distance from the second location.

In a second aspect, the present disclosure provides an apparatus for determining a potential pathway of an object, the pathway comprising a plurality of locations at which the object is detected at a corresponding plurality of detection times, the apparatus comprising: at least one processor; and at least one memory including computer program code; the at least one memory and the computer program code configured to, with at least one processor, cause the server at least to: determine, if a first location at which a first object is detected at a detection time along a first pathway of the first object is within a ground distance from a second location at which a second object is detected at or after the detection time along a second pathway of the second object; and join at least a part of the first pathway detected before the detection time, at least one of the first location and the second location, and at least a part of the second pathway detected after the detection time to form a continuous potential pathway of the first object in response to the determination of the first location being within the ground distance from the second location.

In a third aspect, the present disclosure provides a system for determining a potential pathway of an object comprising the apparatus according to the second aspect, an object tracking apparatus and an imaging capturing apparatus.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

Embodiments of the disclosure will be better understood and readily apparent to one of ordinary skill in the art from the following written description, by way of example only, and in conjunction with the drawings, in which:

FIG. 1 shows a schematic diagram illustrating a plan view of a room and a system installed therein for determining a potential pathway of a person 102 according to an embodiment of the present disclosure.

FIG. 2 shows a schematic diagram illustrating a plan view of a room and a system installed therein for determining a potential pathway of a person 202a according to an embodiment of the present disclosure.

FIG. 3 shows a schematic diagram illustrating a plan view of a room and a system installed therein for determining a potential pathway of a person 202a according to another embodiment of the present disclosure.

FIG. 4 illustrates a block diagram of a system for determining a potential pathway of an object.

FIG. 5 shows a flow chart illustrating a method for determining a potential pathway of an object according to various embodiments of the present disclosure.

FIG. 6 shows a block diagram illustrating a system for determining a potential pathway of an object according to various embodiments of the present disclosure.

FIG. 7 shows a schematic diagram illustrating a system for determining a potential pathway of a person according to a first embodiment of the present disclosure.

FIG. 8A shows diagram illustrating a potential pathway of an object determined by the system of FIG. 7.

FIG. 8B shows diagram illustrating a potential pathway of an object determined by the system of FIG. 7.

FIG. 9 depicts a schematic diagram illustrating an angle of an example determination area according to an embodiment of the present disclosure.

FIG. 10 depicts a schematic diagram illustrating a length of an example determination area according to an embodiment of the present disclosure.

FIG. 11A depicts a person tracking scenario where two persons (target person and person A) with different heights and distances from a tracking sensor are tracked according to an embodiment of the present disclosure.

FIG. 11B depicts a person tracking scenario where two persons (target person and person A) with different heights and distances from a tracking sensor are tracked according to an embodiment of the present disclosure.

FIG. 11C depicts a person tracking scenario where two persons (target person and person A) with different heights and distances from a tracking sensor are tracked according to an embodiment of the present disclosure.

FIG. 12 depicts a schematic diagram illustrating an object tracking sub-system for determining a potential pathway of a person according to various embodiments of the present disclosure.

FIG. 13 depicts a diagram illustrating an object tracking system for determining a potential pathway of a person according to various embodiments of the present disclosure.

FIG. 14 depicts a reliability score calculation table according to an embodiment of the present disclosure.

FIG. 15A illustrates an example track group table of a target object according to an embodiment of the present disclosure.

FIG. 15B depicts a schematic diagram illustrating pathways of different association levels according to an embodiment of the present disclosure.

FIG. 16 depicts a flow chart illustrating a process of forming an object's track group according to an embodiment of the present disclosure.

FIG. 17 shows a schematic diagram illustrating a system comprising an object tracking sub-system for determining a potential pathway of a person according to the second embodiment of the present disclosure.

FIG. 18 depicts an example track group table of a target object according to the second embodiment of the present disclosure.

FIG. 19A depicts a flow chart illustrating a process of forming a target person's track group according to the second embodiment of the present disclosure.

FIG. 19B depicts a flow chart illustrating a process of forming a target person's track group according to the second embodiment of the present disclosure.

FIG. 19C depicts a flow chart illustrating a process of forming a target person's track group according to the second embodiment of the present disclosure.

FIG. 20A depicts a flow chart illustrating a process of displaying a potential pathway of an object under multiple sensors setting according to an embodiment of the present disclosure.

FIG. 20B depicts a flow chart illustrating a process of displaying a potential pathway of an object under multiple sensors setting according to an embodiment of the present disclosure.

FIG. 20C depicts a flow chart illustrating a process of displaying a potential pathway of an object under multiple sensors setting according to an embodiment of the present disclosure.

FIG. 20D depicts a flow chart illustrating a process of displaying a potential pathway of an object under multiple sensors setting according to an embodiment of the present disclosure.

FIG. 21A depicts an example target person's track group table and the relevant tracks according to an embodiment of the present disclosure.

FIG. 21B depict a diagram illustrating a potential pathway of an object according to an embodiment of the present disclosure.

FIG. 22A depicts a schematic diagram illustrating a system comprising two object tracking sensors for determining a potential pathway of an object according to an embodiment of the present disclosure.

FIG. 22B depicts a schematic diagram illustrating a system comprising two object tracking sensors for determining a potential pathway of an object according to an embodiment of the present disclosure.

FIG. 23 shows a schematic diagram illustrating a system comprising an object tracking sub-system for determining nearby tracks and potential contacts of a target person according to an embodiment of the present disclosure.

FIG. 24 shows a schematic diagram illustrating a system comprising an object tracking sub-system for determining nearby tracks and potential contacts of a target person according to another embodiment of the present disclosure.

FIG. 25 depicts a flow diagram illustrating a process of determining a potential pathway of an object and correcting the potential pathway and its data entry in a database (DB) in communication to a sensor and/or a person monitoring server according an embodiment of the present disclosure.

FIG. 26 shows a schematic diagram of an exemplary computing device suitable for use to execute the method in FIG. 5 and implement the apparatus in FIG. 6.

### DESCRIPTION OF EMBODIMENTS

### Terms Description

Object—an object may be a person, a pet, a vehicle, a thing, an item, a device, a pillar, a furniture, or any matter that is stationery or in motion. An object can be living or non-living. In the case of a living or biological object such as a person and a pet, the object can be typically detected based on a facial feature, a body part, a characteristic, and a motion of the object or a combination thereof.

Examples of a facial feature of an object (person) includes relative position, size, shape and/or contour of eyes, nose, cheekbones, jaw and chin, and also iris pattern, skin colour, hair colour or a combination thereof. A characteristic includes physical characteristic such as height, body size, body ratio, length of limbs, hair colour, skin colour, apparel, belongings, other similar characteristics or combinations. A motion may include behavioural characteristic such as body movement, position of limbs, direction of movement, moving speed, walking patterns, the way the object stands, moves, talks, or change in physical characteristic upon interaction with other objects, other similar characteristics or combinations. In the case of a non-living object, the object can be typically based on shape, color, moving speed, moving characteristic/patterns and change in physical characteristic upon interaction with other objects.

In various embodiments of the present disclosure, an object can be detected by an image capturing apparatus such as a camera by capturing an image of the object and identifying the object based on its facial feature, body part, characteristic and/or motion of the object in the image. Additionally or alternatively, an object can be detected by an object tracking apparatus such as a LiDAR where detecting an array of light pulses emitted by the object tracking apparatus and reflected back from surrounding objects, measuring distances (e.g., angular distance and axial distance) between the objects and the object tracking apparatus based on the detected light pulses, optionally generating a 3D map of all objects around the object tracking apparatus based on their respective distances and tracking the change in distance of an object to the object tracking apparatus over time and identifying its pathway. In general, object tracking apparatuses such as LiDAR can provides wide area fine-grained tracking as compared to an image capturing apparatus which detections are limited to its field of view. In various embodiments below, the term “sensor” may be used to refer to either one or both of an image capturing apparatus and an object tracking apparatus.

In various embodiments, an object, upon detection, and the data obtained by the sensor, used for and associated with the identification and detection of the object will be assigned to an object identifier for subsequent identification and tracking of the object. A same object ID will be assigned when the object is subsequently identified based on the same or other facial feature, body part, characteristic, motion of the object or combination thereof.

In various embodiments below, an object may refer to as a target object when determinations of potential pathways are carried out on the object.
Location—a location is a position or a spot within a space at which an object is detected by a sensor. The space could be an open space, an enclosed space like a room, or correspond to a field of view of a sensor detecting the object. It is noted that a sensor which detects and tracks the pathway of the object is typically mounted on a wall or ceiling and is located at a distance away from the object.

In one embodiment, an X-Y coordinate with reference to a sensor or a point (e.g., corner or center) of a space may be used to designate a location and to quantify a ground distance between two locations (e.g., a distance between two objects or a distance between an object and the sensor). In another embodiment, a polar coordinate with reference to a sensor using pan angles (or radian), tilt angles (radian) and/or focal lengths of the sensor may be used to designate the location and to quantify the ground distance. For example, the sensor may be pre-configured with a reference line/plane within the space and an object may be detected at a certain angular distance (or angle) away from the reference line/plane, or with a reference position/location in the space and an axial distance between an object and the reference position/location of the sensor may be calculated based on tilt angles (radian), known or pre-configured height (e.g., average human height) of the object and/or focal length of sensor to put the object in focus.

In various embodiments, the term “location” may be referred to as “detection point”. The location data of an object and its corresponding time data associated with the detection of the object are recorded for processing and determining a pathway of the object.

Detection time—a detection time is a timestamp at which an object is detected by a sensor. In various embodiments, such time data of an object and its corresponding location data associated with the detection of the object are recorded for processing, determining a pathway of the object.
Pathway—a pathway is a passage or path connecting multiple locations (detection points) of an object, detected under a same subject ID, over a continuous time period. More specifically, a pathway of an object can be determined when there are multiple instances of an object under a same object ID being detected by a sensor within the space (e.g., field of view of the sensor) over a continuous period of time, and by concatenating/joining the respective detection points (locations) from the multiple detection instances according to their
Potential pathway—a potential pathway is a pathway that may potentially represent the accurate pathway of an object. This potential pathway may be different from that present object's pathway. Such potential pathway of an object (target object) is determined when the present object's pathway tracking is not reliable, or a system or an apparatus detecting the present object's pathway is no longer confident and accurately representing the accurate pathway of the object. For example, the confidence level of an object's pathway may be affected when there was a blockage of line of sight at one detection point along the object's pathway, when there was another object moving close to the object around a detection point, when the object had an abrupt change in its pathway, when the object suddenly disappeared from the detection area or when a new object was detected near to a point where the object was last detected.
Ground distance—a ground distance is a distance extended from a detection point of a target object, thereby forming an area centered around the detection point of the target object, and such distance or area is used for searching and determining if another object is also detected around the same time or short thereafter as that of the detection point, which in turn used to determine if tracking of the target object is reliable and a potential (alternative) pathway(s) of the target object.

In one embodiment, such ground distance is fixed and extended outwards in all directions from the detection point of the object, thereby forming a circular area with a fixed radius centered around the detection point of the object.

In another embodiment, the ground distance may also be extended from the detection point with reference to the sensor. For example, the ground distance may be extended from the detection point an axial distance closer to and away from the reference position/location of the sensor and an angular distance closer to and away from the reference line/plane of the sensor, thereby forming a rectangular area centered around the detection point of the object.

### EXEMPLARY EMBODIMENTS

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system, Long Term Evolution (LTE) system and 5G mobile network system. The computer program when loaded and executed on such a computer effectively results in an apparatus that implements the steps of the preferred method.

Various embodiments of the present disclosure relate to a method and an apparatus for determining a potential pathway of an object. It is appreciated by a skilled person that such apparatus and the image capturing device may be implemented as part of a system to provide the same technical effect.

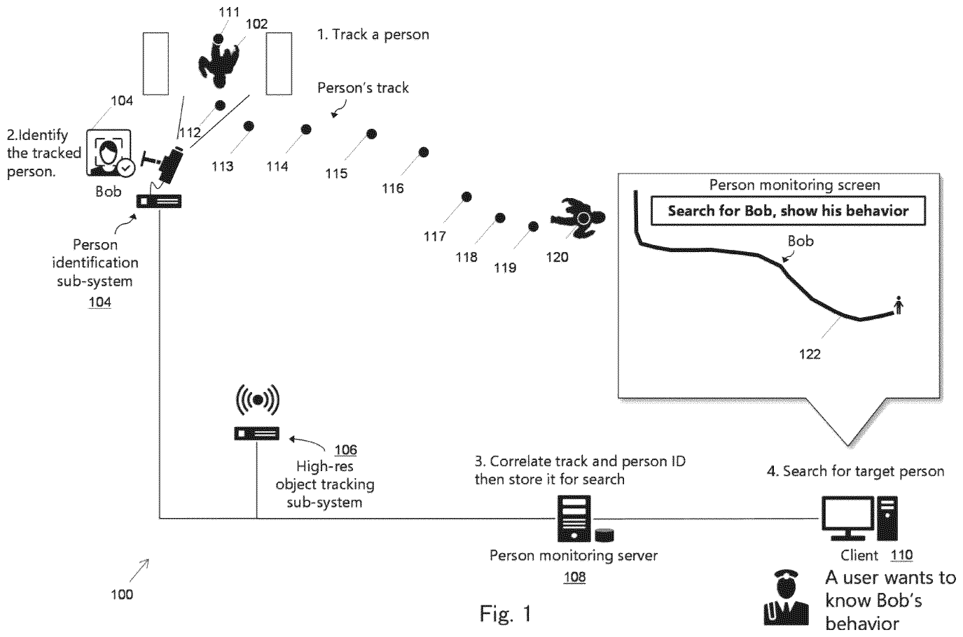

FIG. 1 shows a schematic diagram 100 illustrating a plan view of a room and a system installed therein for determining a potential pathway of a person 102 according to an embodiment of the present disclosure. The system may comprise a person identification sub-system 104 and a high-resolution object tracking sub-system 106 working in synchronization. The person identification sub-system 104 comprises an image capturing apparatus such as camera configured to capture images of an entrance of a room and any person who appears at the entrance, and the person identification sub-system 104 is configured to identify a person ID (or object ID) of the person based on its facial feature in the image, for example by comparing the facial feature against all facial features in a database in communication with the person identification sub-system 104. The object tracking sub-system 106 may be configured to scan the whole room to detect all objects within its line-of-sight in the room at a regular interval, including any object (person) which (who) at the entrance. The object tracking sub-system 106 will correlate the object at the entrance to the person at the entrance identified by the person identification sub-system 104 and assign the same person ID (or object ID) to the object. As such, subsequent detections of the object by the object tracking sub-system 106 and the detection data (e.g., object figure/contour data, location data and time data) of the object will be assigned to the same person ID (object ID) and stored in a database or a person monitoring server 108 for subsequent object track search, identification and monitoring purposes.

A person who walks around the room over a period of time spanning across multiple detection times/intervals of the object tracking sub-system 106 will cause the object tracking sub-system 106 to generate multiple detection points of the person under the same person ID correspondingly.

In this embodiment, a person 102 enters the room and the person identification sub-system 104 captures an image 104 of the person 102 and identify a person ID of the person 102 (e.g., person ID “Bob”). Separately, the object tracking sub-system 106 may also detect multiple objects within the room including the object (in this case, the person 102) at the entrance at point 111 and correlate the object 102 to the person ID “Bob”. As the person 102 moves around in the room subsequently, the object tracking sub-system 106, which scans all objects across the room at a regular interval, will detect the object under the person ID “Bob” at multiple detection points in the room, as illustrated using points 111-120. Such detection data and associated person IDs will then be stored in the database in communication with the person monitoring server 108. The multiple detection points of the object can then be concatenated/joined according to the chronological order to determine a pathway 122 of the object in the room and displayed in a client device or server 110.

Such object tracking method using multiple modes of sensors works well when there is line-of sight from the sensors to the person being tracked, but when there are occlusions caused by another person or object, e.g., pillar, coming in between, it may result in the track ID (e. g., object ID or person ID) being swapped with the other person or object mistakenly, or the track ID to be broken because the system is no longer confident and a new track ID is assigned to the person as if a new person or object is detected.

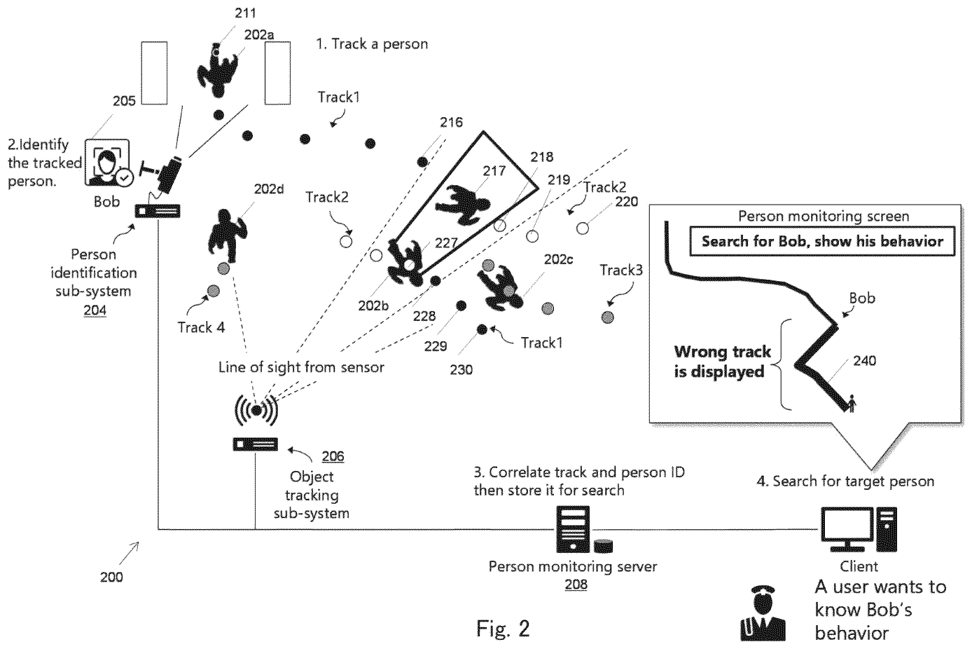

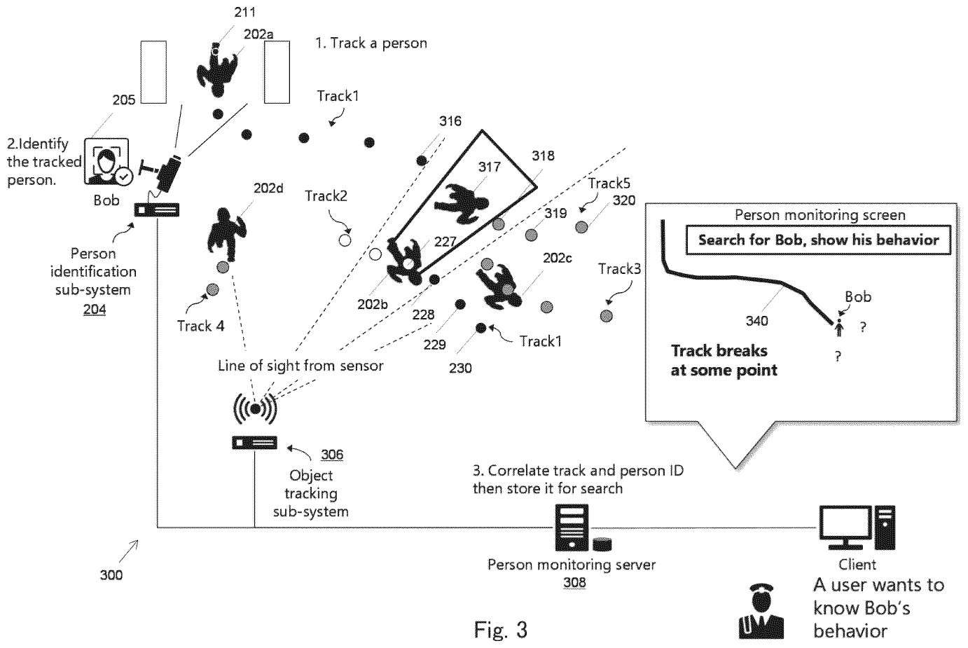

As mentioned earlier, person tracking may become not reliable when there is a blockage of line of sight. FIGS. 2 and 3 each shows a schematic diagram 200, 300 illustrating a plan view of a room and a system installed therein for determining a potential pathway of a person 202a according to an embodiment of the present disclosure. The person 202a enters the room and the person identification sub-system 204 captures an image 205 of the person 202 a and identify a person ID of the person 202a (e.g., person ID “Bob”). Separately, the object tracking sub-system 206 may also detect the person at point 211 and correlate the object 202 a to the person ID “Bob” as well as other persons under different person IDs in the room including persons 202b, 202c and 202d. As the persons 202a-d move around in the room, the object tracking sub-system 206, which scans all objects across the room at a regular interval, will detect the person 202a and other persons 202b-d at multiple detection points in the room, correlate their detection data (e.g., object figure/contour data, location data and time data) under their respective person IDs and stored in a monitoring server 208.

However, in one example, as illustrated in FIG. 2, when the person 202a walks to point 217, the person 202b may stand in between the person 202a and the object tracking sub-system 204 and block the line of sight (as illustrated using dashed lines in FIG. 2) from the sub-system 206 to the person 202 a. As such, the object tracking sub-system 206 cannot detect the location of the person 202 a (Bob) and possibly identify the person 202b standing at point 227 as the person 202a instead and identify the person 202a at point 217 as the person 202b. Their person IDs can be switched before and after the blockage. As such, the subsequent movements of the person 202b and detections of the person 202b at points 227-230 may be characterized under person 202a with the person ID “Bob” (Track 1) and subsequent movements of the person 202a and detections of the person 202a at points 217-220 may be characterized under person 202b with its person ID (Track 2). As a result, when a user request to display Bob's behaviour by retrieving track 1, a wrong pathway 240 of Bob may be displayed in the screen of a client device or server 210.

In an alternative example, as illustrated in FIG. 3, when the person 202a walks to point 317, the person 202b may stand in between the person 202a and the object tracking sub-system 306 and block the line of sight (as illustrated using dashed lines in FIG. 3) from the sub-system 306 to the person 202 a, and the object tracking sub-system 306 cannot detect the location of the person 202 a. As a result, the object tracking sub-system 306 may lose track of the person 202 a after point 316 and the subsequent movements of the person 202a and detections of the person 202a at points 317-320 are characterized as those of a new person 202e under a new person ID (track 5) while the subsequent movements of the person 202b and detections of the person 202b at points 227-230 may be characterized under person 202a with the person ID “Bob” (Track 1). As a result, a wrong or incomplete pathway 340 of the person 202a ending on point 316 is displayed in the screen of a client device or server 210.

There is thus a need to provide a method and an apparatus capable of determining a potential pathway of an object to address the above-mentioned issues and limitations.

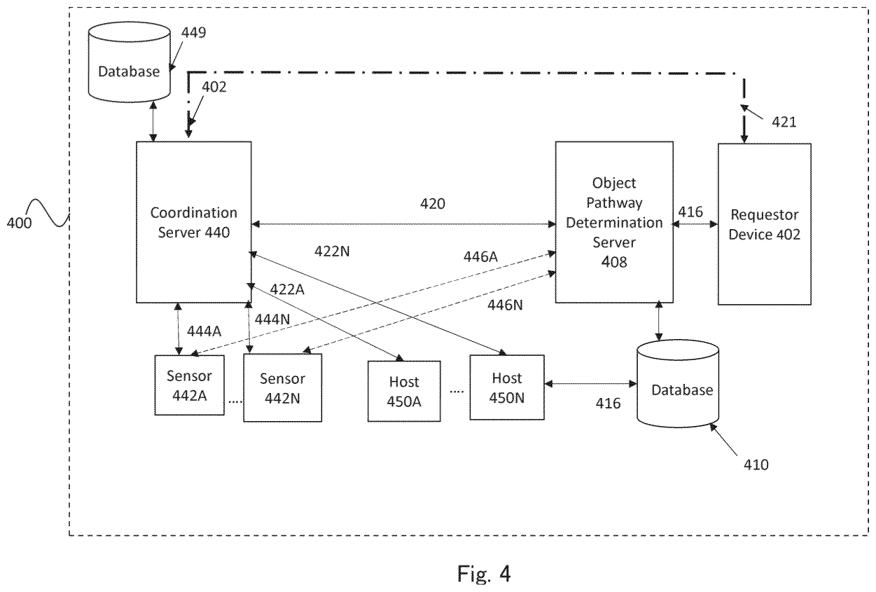

FIG. 4 illustrates a block diagram of a system 400 for determining a potential pathway of an object.

The system 400 comprises a requestor device 402, an object pathway determination server 408, a coordination server 440, hosts 450A to 450N, and sensors 442A to 442N.

The requestor device 402 is in communication with an object pathway determination server 408 and/or a coordination server 440 via a connection 416 and 421, respectively. The connection 416 and 421 may be wireless (e.g., via NFC communication, Wi-Fi communication, Bluetooth, etc.) or over a network (e.g., the Internet). The connection 416 and 421 may also be that of a network (e.g., the Internet).

The object pathway determination server 408 is further in communication with the coordination server 440 via a connection 420. The connection 420 may be over a network (e.g., a local area network, a wide area network, the Internet, etc.). In one arrangement, the object pathway determination server 408 and the coordination server 440 are combined and the connection 420 may be an interconnected bus.

The coordination server 440, in turn, is in communication with the hosts 450A to 450N via respective connections 422A to 422N. The connections 422A to 422N may be a network (e.g., the Internet).

The hosts 450A to 450N are servers. The term host is used herein to differentiate between the hosts 450A to 450N and the coordination server 440.

The hosts 450A to 450N are collectively referred to herein as the hosts 450, while the host 450 refers to one of the hosts 450. The hosts 450 may be combined with the coordination server 440.

In an example, the host 450 may be one managed by a security officer of the entity and the coordination server 440 is a central server that coordinates the hosts 450 and decides which of the hosts 450 to forward data or retrieve data like image inputs.

Sensors 442A to 442N are connected to the coordination server 440 or the object pathway determination server 408 via respective connections 444A to 444N or 446A to 446N. The sensors 442A to 442N are collectively referred to herein as the sensors 442. The connections 444A to 444N are collectively referred to herein as the connections 444, while the connection 444 refers to one of the connections 444. Similarly, the connections 446A to 446N are collectively referred to herein as the connections 446, while the connection 446 refers to one of the connections 446. The connections 444 and 446 may be wireless (e.g., via NFC communication, Wi-Fi communication, Bluetooth, etc.) or over a network (e.g., the Internet). The sensor 442 may be one of an image capturing device, object tracking device, video capturing device, motion sensor and temperature sensor, and may be configured to send an input depending its type, to at least one of the object pathway determination server 408.

In the illustrative embodiment, each of the devices 402 and 442; and the servers 408, 440, and 450 provides an interface to enable communication with other connected devices 402 and 442 and/or servers 408, 440, and 450. Such communication is facilitated by an application programming interface (“API”).

Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof.

Use of the term ‘server’ herein can mean a single computing device or a plurality of interconnected computing devices which operate together to perform a particular function. That is, the server may be contained within a single hardware unit or be distributed among several or many different hardware units.

### The Coordination Server 440

The coordination server 440 is associated with an entity (e.g. a company or organization or moderator of the service). In one arrangement, the coordination server 440 is owned and operated by the entity operating the server 408. In such an arrangement, the coordination server 440 may be implemented as a part (e.g., a computer program module, a computing device, etc.) of server 408.

The coordination server 440 may also be configured to manage the registration of users. A registered user has an object tracking account which includes details of the user. The registration step is called on-boarding. A user may use either the requestor device 402 to perform on-boarding to the coordination server 440.

It is not necessary to have an object tracking account at the coordination server 440 to access the functionalities of the coordination server 440. However, there are functions that are available to a registered user. For example, it may be possible to customize ground distance or area around an object's pathway to increase or decrease the number of objects that may be associated with the target object and display graphical representation of association levels of other objects with the target object as well as the pathway of the other objects that have a high association level with the target object. These additional functions will be discussed below.

The on-boarding process for a user is performed by the user through one of the requestor device 402. In one arrangement, the user downloads an app (which includes the API to interact with the coordination server 440) to the sensor 442. In another arrangement, the user accesses a website (which includes the API to interact with the coordination server 440) on the requestor device 402.

Details of the registration include, for example, user identifier (ID) or facial portrait of the user, address of the user, contact, or other important information and the sensor 442 that is authorized to update the object tracking account, and the like.

Once on-boarded, the user would have an object tracking account that stores all the details.

### The Requestor Device 402

The requestor device 402 is associated with a subject (or requestor) who is a party to an object pathway determination request that starts at the requestor device 402. The requestor may be a concerned member of the public or a security officer of an entity who is assisting to get data necessary to obtain a graphical representation of a pathway of an object within the entity. The requestor device 402 may be a computing device such as a desktop computer, an interactive voice response (IVR) system, a smartphone, a laptop computer, a personal digital assistant computer (PDA), a mobile computer, a tablet computer, and the like.

In one example arrangement, the requestor device 402 is a computing device in a watch or similar wearable and is fitted with a wireless communications interface.

### The Object Pathway Determination Server 408

The object pathway determination server 408 is as described above in the terms description section.

The object pathway determination server 408 is configured to determine a potential pathway of an object.

### The Hosts 450

The host 450 is a server associated with an entity (e.g. a company or organization) which manages (e.g. establishes, administers) object information for example detection data and pathways or potential pathways of objects.

In one arrangement, the entity is a bank. Therefore, each entity operates a host 450 to manage the resources by that entity. In one arrangement, a host 450 receives an alert signal that a confidence level of an object's pathway or its detection points in a detection space or within a detection time period is low. The host 450 may then arrange to send resources to process detection data relating to the object and its associates or in the detection space or around the detection time period obtained by the sensor 442. For example, the host 450 may be one that is configured to obtain relevant video or image input for processing.

### Sensor 442

The sensor 442 is associated with a user associated with the requestor device 402. The sensor 442 may be one of an image capturing device, object tracking device, video capturing device, motion sensor and temperature sensor, and may be configured to send an input depending its type, to at least one of the object pathway determination server 408. More details of how the sensor may be utilised for determining a potential pathway of an object will be provided below.

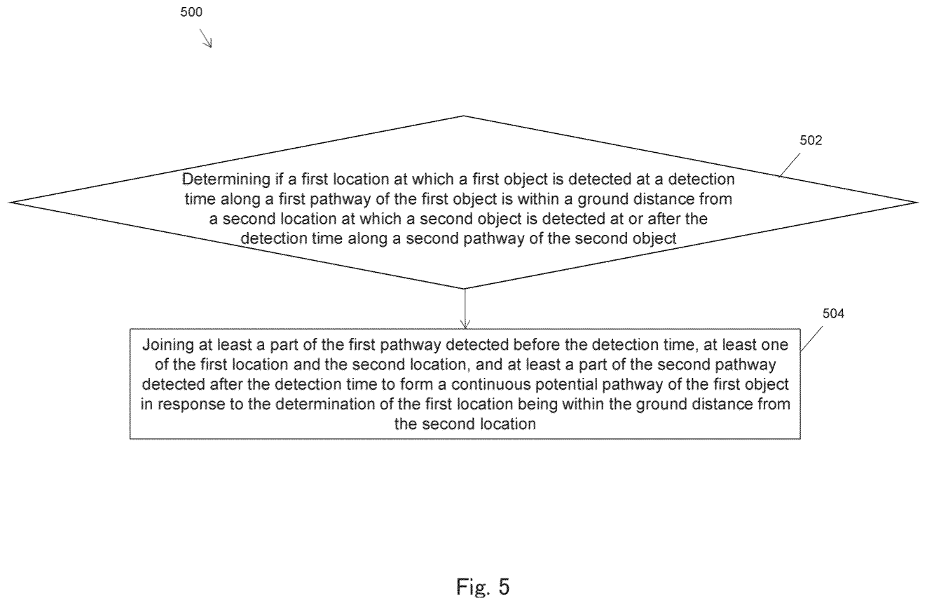

FIG. 5 shows a flow chart 500 illustrating a method for determining a potential pathway of an object according to various embodiments of the present disclosure. In step 502, a step of determining if a first location at which a first object is detected at a detection time along a first pathway of the first object is within a ground distance from a second location at which a second object is detected at or after the detection time along a second pathway of the second object is carried out. In step 504, a step of joining at least a part of the first pathway detected before the detection time, at least one of the first location and the second location, and at least a part of the second pathway detected after the detection time to form a continuous pathway of the first object is carried out in response to the determination of the first location being within the ground distance from the second location in step 502.

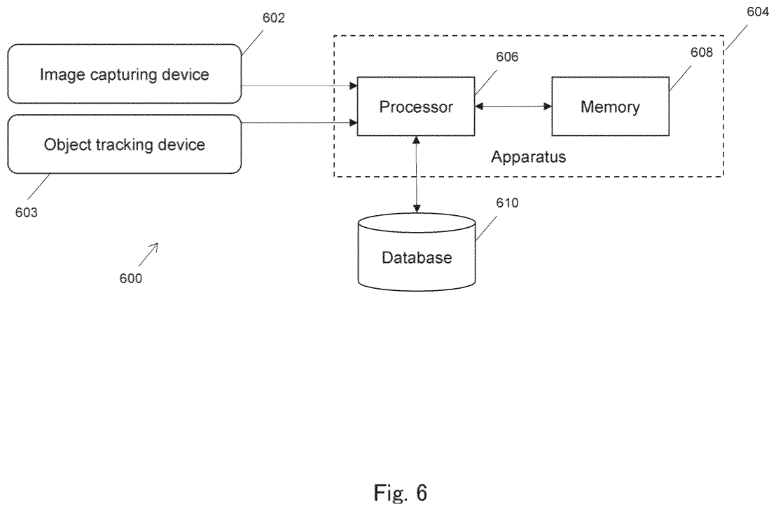

FIG. 6 shows a block diagram illustrating a system 600 for determining a potential pathway of an object according to various embodiments of the present disclosure.

In an example, the managing of image input and signal input is performed by at least an image capturing device 602, an object tracking device 603 and an apparatus 604. The system 600 comprises an image capturing device 602 and an object tracking device 604 in communication with the apparatus 604. In an implementation, the apparatus 604 may be generally described as a physical device comprising at least one processor 606 and at least one memory 608 including computer program code. The at least one memory 608 and the computer program code are configured to, with the at least one processor 606, cause the physical device to perform the operations described in FIG. 5. The processor 606 is configured to receive a plurality of input images from the image capturing device 602 and a plurality of input signals (e.g., light pulses, object locations) from the object tracking device 603 or retrieve a plurality of input images and a plurality of input signals from a database. Alternatively or additionally, the plurality of input images captured by the image capturing device 602 and the plurality of input signals (e.g., light pulses, object locations) from the object tracking device 603 are stored in a database 610, and the processor 606 is configured to retrieve the plurality of input images and the plurality of input signals from the database 610.

The image capturing device 602 may be a device such as a closed-circuit television (CCTV) which provides a variety of data (camera data) of which appearance data that can be used by the system to detect appearances and identify a person or an object under a person/object ID. In an implementation, the data derived from the image capturing device 602 may be stored in memory 608 of the apparatus 604 or a database 610 accessible by the apparatus 604. The appearance data may include (i) facial feature data such as relative position, size, shape and/or contour of eyes, nose, cheekbones, jaw and chin, and also iris pattern, skin colour, hair colour or a combination thereof, (ii) physical characteristic data such as height, body size, body ratio, length of limbs, hair colour, skin colour, apparel, belongings, other similar characteristics or combinations, and (iii) behavioral characteristic data such as body movement, position of limbs, direction of movement, moving speed, walking patterns, the way a person/object stands, moves, talks, change in physical characteristic upon interaction with other persons/objects, other similar characteristics or combinations.

The object tracking device 603 may be a device such as a LiDAR sensor which provides a variety of data (map data) of which object figure data and location data that can be used by the system to generate a 3D map of surrounding objects and track a location and pathway of a person/object. In an implementation, the data derived from the object tracking device 603 may be stored in memory 608 of the apparatus 604 or a database 610 accessible by the apparatus 604. The object figure data may be include (i) facial feature data such as relative position, size, shape and/or contour of eyes, nose, cheekbones, jaw and chin or a combination thereof, (ii) physical characteristic data such as height, body size, body ratio, length of limbs, apparel, belongings, other similar characteristics or combinations, and (iii) behavioral characteristic data such as body movement, position of limbs, direction of movement, moving speed, walking patterns, the way a person/object stands, moves, talks, change in physical characteristic upon interaction with other persons/objects, other similar characteristics or combinations.

In an implementation, camera data and map data such as location (e.g., in term of X-Y coordinates, pan/tilt angles and focal length) and resolution, and/or time data which includes a timestamp at which the one or more persons are identified may also be derived from the image capturing device 602 and object tracking device 603. The camera data, track data and/or time data may be stored in memory 608 of the apparatus 604 or a database 610 accessible by the apparatus 604 and the processor 606 is configured to identify and retrieve appearance data, images, object figure data, 3D object map based on the time data. It should be appreciated that the database 610 may be a part of the apparatus 604.

According to the present disclosure, the apparatus 604 may be configured to communicate with the image capturing device 602 and the object tracking device 603 and the database 610. In an example, the apparatus 604 may receive, from the image capturing device 602, or retrieve from the database 610, a plurality of images relating to a same field of view of the image capturing device as input, and after processing by the processor 606 in apparatus 604, generate an output such as a person/object ID of a person/object identified from the input, the output which may be used by the object tracking device 603 to determine a pathway and a potential pathway of the object/person.

More particularly, the memory 608 and the computer program code stored therein are configured to, with the processor 606 cause the apparatus 604 or the image capturing device 602 directly to detect an appearance of an object(s) as it enters a detection space, compare its appearance data against data stored in the database 610, and assign an identification (e.g. person ID) to the object(s).

The memory 608 and the computer program code stored therein are configured to, with the processor 606 cause the apparatus 604 or the object tracking device 603 directly to generate a pulsed laser across the detection space; and detect the pulsed laser reflected by the object(s) to detect and determine a plurality of locations within the detection space at which the object(s) is located at different detection time across a detection time period, and form a pathway of the object(s) based on the plurality of locations of the object(s) and their detection times for example by concatenating/joining the plurality of locations of the object(s) according to their chronological order (detection times) at which they are detected.

The memory 608 and the computer program code stored therein are configured to, with the processor 606 may cause the apparatus 604 to further; associate the identification assigned the object to the object detected by the object tracking device 603.

In various embodiments of the present disclosure, the memory 608 and the computer program code stored therein are configured to, with the processor 606 cause the apparatus 604 to determine a potential pathway of a target (first) object comprising a plurality of locations at which the target object is detected at a corresponding plurality of detection time by determining if a first location at which the first object is detected at a detection time along a first pathway of the first object is within a ground distance from a second location at which a second object is detected at or after the detection time along a second pathway of the second object, and joining at least a part of the first pathway detected before the detection time, at least one of the first location and the second location, and at least a part of the second pathway detected after the detection time to form a continuous potential pathway of the first object in response to the determination of the first location being within the ground distance from the second location.

In an embodiment, the memory 608 and the computer program code stored therein are configured to, with the processor 606 may cause the apparatus 604 to further join the remaining part of the second pathway, the remaining one of the at least one of the first location and the second location and the remaining part of the first pathway to form a continuous potential pathway of the second object.

The memory 608 and the computer program code stored therein are configured to, with the processor 606 may cause the apparatus 604 to further determine if the second location is within a ground area centered around the first location.

In another embodiment, where the first location is at a distance away from a location of an object tracking apparatus configured to track the first object along the first pathway and the second object along the second pathway and an angular distance from a reference line of the object tracking apparatus, and the ground area centered around the first location spans across an axial distance closer to and away from the location of the object tracking apparatus and an angular distance closer to and away from the reference line of the object tracking apparatus, the memory 608 and the computer program code stored therein are configured to, with the processor 606 may cause the apparatus 604 to determine if the location of the object tracking apparatus is closer to the second location than to the first location, and if a height of the second object is greater than that of the first object and join the at least the part of the first pathway detected before the detection time, the at least one of the first location and the second location and the at least the part of the second pathway detected after the detection time to form the continuous potential pathway of the first object is carried out in further response to one of (a) the determination of the location of the object tracking apparatus being closer to the second location and the height of the second object being greater than that of the first object and (b) the determination of the location of the object tracking apparatus being closer to the first location and the height of the first object being greater than that of the second object.

Yet in another embodiment, the memory 608 and the computer program code stored therein are configured to, with the processor 606 may cause the apparatus 604 to further compare at least one of (a) a size of the first object at a preceding first location along the first pathway, the preceding first location being a location at which the first object is detected outside the ground area before the detection time, is comparable to that of the second object at a subsequent second location along the second pathway, the subsequent second location being a location at which the second object detected outside of the ground area after the detection time, and (b) a moving speed of the first object along the first pathway at the preceding first location is comparable to that of the second object along the second pathway at the subsequent second location and join the at least the part of the first pathway detected before the detection time, the at least one of the first location and the second location and the at least the part of the second pathway detected after the detection time to form the continuous potential pathway of the first object is carried out in response to a result of the comparison of the at least one of the sizes and the moving speeds of the first object and the second object.

Additionally, the memory 608 and the computer program code stored therein are configured to, with the processor 606 may cause the apparatus 604 to further apply different weightages to the result of the comparison of the sizes and the result of the comparison of the moving speeds to calculate a score; and determine if the score is higher than that calculated based on a result of another comparison of (a) a size of the first object at a subsequent first location and the size of the first object at the preceding first location and (b) a moving speed of the first object along the first pathway at the subsequent first location and the moving speed of the first object along the first pathway at the preceding first location, the subsequent first location being a location at which the first object is detected outside the ground area after the detection time and join the at least the part of the first pathway detected before the detection time, the at least one of the first location and the second location and the at least the part of the second pathway detected after the detection time to form the continuous potential pathway of the first object is carried out in response to the determination of the score being higher than that calculated based on the result of the other comparison.

Alternatively and additionally, the memory 608 and the computer program code stored therein are configured to, with the processor 606 may cause the apparatus 604 to further determine if at least one of a size of the first object and/or the second object is within a normal human size range, and a moving speed of the first object and/or the second object is lower than a human moving speed limit, and then join the at least the part of the first pathway detected before the detection time, the at least one of the first location and the second location and the at least the part of the second pathway detected after the detection time to form the continuous potential pathway of the first object is carried out in further response to the determination of the at least one of the size of the first object and/or the second object being within a normal human size range, and the moving speed of the first object and/or the second object being lower than the human moving speed limit.

Alternatively and additionally, the memory 608 and the computer program code stored therein are configured to, with the processor 606 may cause the apparatus 604 to further display both the first pathway and the second pathway on a graphical interface (not shown); and receive an input (not shown) in response to an enquiry displayed on the graphical interface to join the at least the part of the first pathway detected before the detection time, the at least one of the first location and the second location, and the at least the part of the second pathway detected after the detection time to form the continuous potential pathway of the first object; and join the at least the part of the first pathway detected before the detection time, the at least one of the first location and the second location and the at least the part of the second pathway detected after the detection time to form the continuous potential pathway of the first object is carried out in response to receiving the input.

According to the present disclosure, it is checked if tracking of an object is reliable or not, and if it is not reliable, a potential pathway of the person (e. g., possible nearby tracks) are determined and collected. One way to determine a reliability of object tracking is to determine a reliability each detection point of the person along its present pathway detected by an object tracking device by checking if another object also appears within a detection distance or area from the detection point of the person. Such reliability assessment and potential pathway determination can be carried out retrospectively after all detection data (location and time data) have been obtained and all object pathways have been generated, or simultaneously at the time of identifying and tracking an object pathway and continuously upon detection of every new detection point of the object.

In the following paragraphs, a first embodiment of the present disclosure where a ground area used for determining a reliability of the current tracking of an object and a potential pathway of the object is configured with reference to a reference line/plane and a reference position/location of the object tracking apparatus.

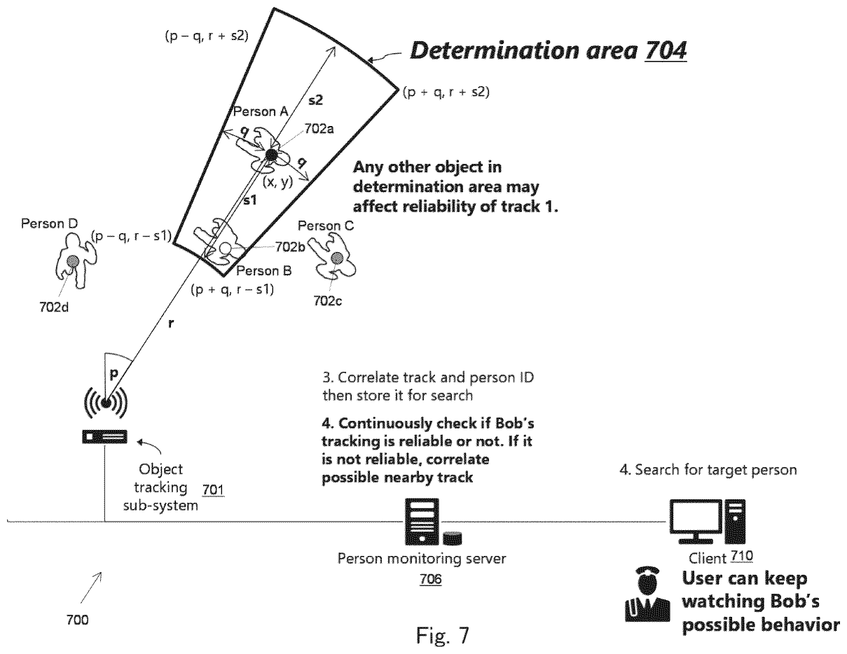

FIG. 7 shows a schematic diagram illustrating a system 700 for determining a potential pathway of a person according to the first embodiment of the present disclosure. In this embodiment, the system 700 comprises an object tracking sub-system 701 is configured to detect all objects moving within its line-of-sight at a regular time interval, identify a pathway of each object within its line-of-sight over and determine a potential pathway of an object. As illustrated in FIG. 7, the object tracking sub-system 701 detects four persons (herein denoted as persons A-D) at different locations (detection points 702a-d) at a detection time t. A person monitoring server 706 of the system 700 may correlates their detection data (e.g., object figure/contour data, location data and time data) under their respective person IDs and stored in a database in communication with the person monitoring server 706. Further, the detection point 702a of the person A is checked by the person monitoring server 706 whether another person (based on his/her detection points) was also detected within a determination area 704 centered around the detection point 702a.

An X-Y coordinate with reference to the object tracking sub-system 701 or a corner of a room may be used to indicate the detection point, for example the position of the object tracking sub-system 701 has a coordinate of (0, 0) and the detection point 702a has a coordinate of (x, y) indicating the detection point 702a is x distance away from the object tracking sub-system 701 along the x-axis and y distance away from the object tracking sub-system 701 in the-axis orthogonal to the x-axis. Alternatively, polar coordinates with reference to the object tracking sub-system may be used to indicate the detection points, for example the position of the object tracking sub-system 701 has a polar coordinate of (0, 0) and the detection point 702a has a polar coordinate of (p, r) indicating the detection point 702a is an angular distance of p radian (or degree) away from the reference line or plane of the object tracking sub-system 701 and an axial distance of r away from the reference position of the object tracking sub-system 701 at (0,0).

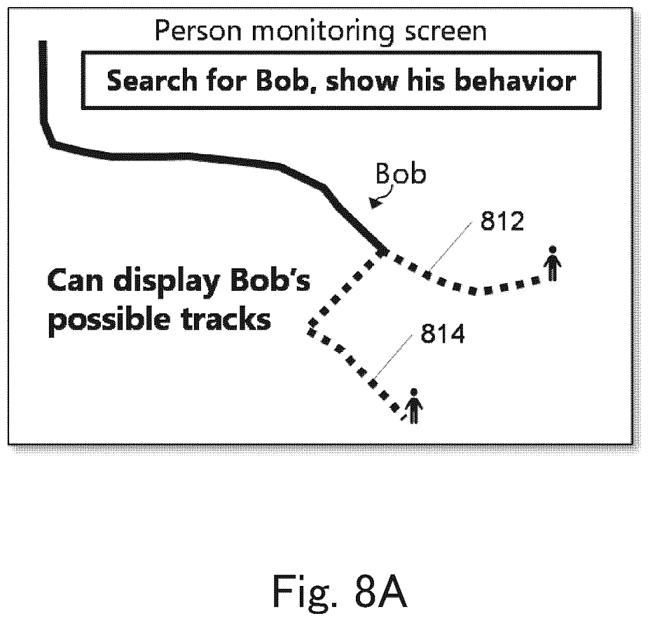

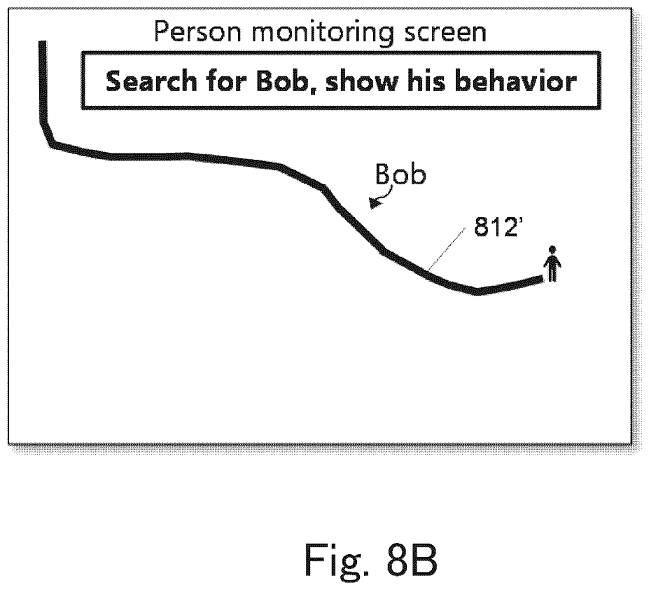

In this embodiment, the determination area 704 spans, from the detection point 702a (p, r), a ground distance (in this case, angular distance q) closer to the reference line/plane of the object tracking sub-system 701, a ground distance (in this case, angular distance q) away from the reference line/plane of the object tracking sub-system 701, a ground distance (in this case, axial distance s1) close to the reference position of the object tracking sub-system 701 and a ground distance (in this case, axial distance s2) away to the reference position of the object tracking sub-system 701, as illustrated in rectangular block 704 having a length of s1+s2 and an angle of 2q with four edge points (p−q, r−s1), (p−q, r+s2), (p+q, r−s1), (p+q, r+s2) in polar coordinates in FIG. 7. It is determined that person B at detection point 702b is within the determination area 704 and therefore, the tracking of person A may not be reliable (or the confidence level of the pathway of person A is low) and person B is also identified as a potential associate of person A. Potential pathways of person A are then collected, for example, by taking into account of subsequent detections and both pathways of person A and person B detected after the detection time t. Such detection data and their associated ID will then be stored in the database in communication with the person monitoring server 706. The multiple detection points and potential detection points of the object can then be concatenated/joined according to the chronological order to determine two potential pathways 812, 814 of the object in the room and displayed in a client device or server 710, as illustrated in FIG. 8A. In one embodiment, the user may interact with the client device or server 810 to select one (e.g., 812′) of the potential pathways as the more accurate pathway of person A, as illustrated in FIG. 8B. The selection may also be stored in the database of the person monitoring server 706. Even though different axial distances s1 and s2 are illustrated, it is appreciated that s1 and s2 can have a same length s0. Similarly, even though a same angular distance q is illustrated, it is appreciated that the ground distance closer to the reference line/plane and the ground distance away from the reference line/plane can be different and replaced by different angular distances q1 and q2, respectively.

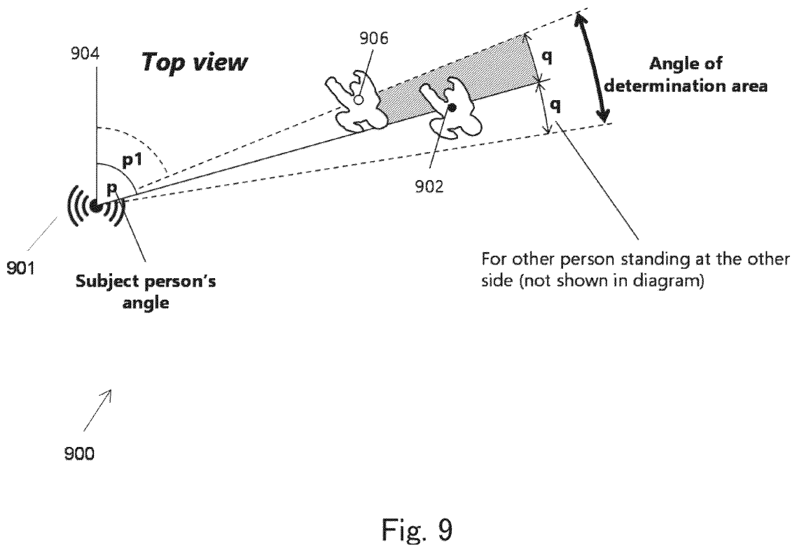

FIG. 9 depicts a schematic diagram 900 illustrating an angle of an example determination area according to an embodiment of the present disclosure. As mentioned above, where an object 902 is detected at an angle (in this case, p degree) from a reference line/plane of the object tracking sensor, the angle of the determination area of the detection point may span, from p, an angle or angular distance (e.g., q degree) closer to the reference line/plane 904 of the object tracking sensor to an angle or angular distance (e.g., q degree) further from the reference line/plane 904. The angle of the determination area is this case is defined as 2q. If another object 906 is detected at an angle p1 falling within the angle of the determination area (i.e., p−p1 is less than q degree), it is determined that the two persons 902, 906 are too close to each other and the tracking of these two persons 902, 906 will not be reliable as major part of one person may be blocked by the other person and the track IDs may be swapped. Such angle of the determination area (e.g., q degree) may be configured based on the object tracking sensor's capability to identify and keep track of two persons. For example, q degree is set because that is the minimum angle the object tracking sensor can resolve two different persons/objects and keep track of them.

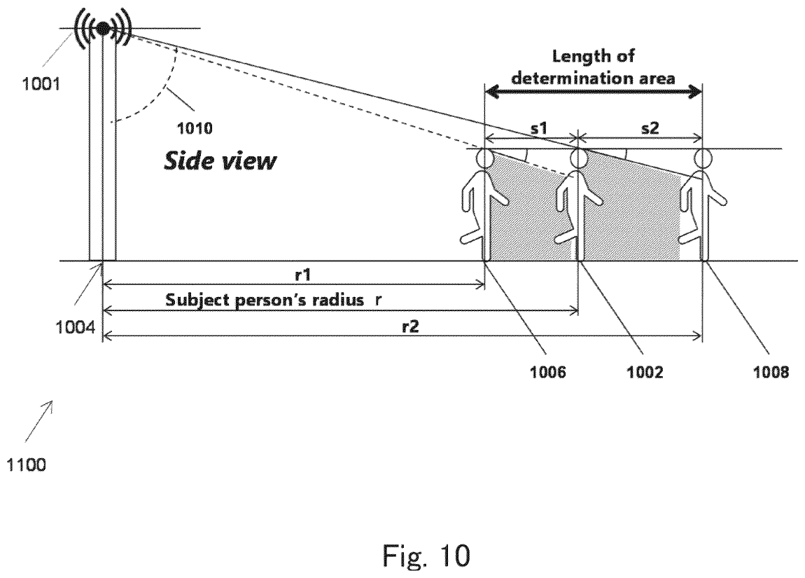

FIG. 10 depicts a schematic diagram 1000 illustrating a length of an example determination area according to an embodiment of the present disclosure. As mentioned above, where an object 1002 is detected at an axial distance (in this case, r radius) from a reference position 1004 of the object tracking sensor 1001, the length of the determination area of the detection point may span, from r, an axial distance (e.g., s1) closer to the reference position 1004 of the object tracking sensor 1001 and an axial distance (e.g., s2) further to the reference position 1004 of the object tracking sensor 1001. The length of the determination is this case is defined as s1+s2. If another object 1006, 1008 is detected at an axial distance or radius r1, r2 falling within the length of the determination area (i.e., r−r1 is less than s1 or r−r2 is less than s2), it is determined that the two persons are too close to each other and the tracking of these two persons will not be reliable as major part of one person may be blocked by the other person and the track IDs may be swapped. Such length of the determination area (e.g., s1 or s2) may be configured based on the object tracking sensor's capability to identify and keep track of two persons, and may relate to tilt angles of the object tracking sensor 1001. For example, s1 and s2 (or tilt angles ta1 and ta2) are set because they are the minimum distances (or tilt angles, e.g., angle 1010) the object tracking can resolve two different person/objects and keep track of them.

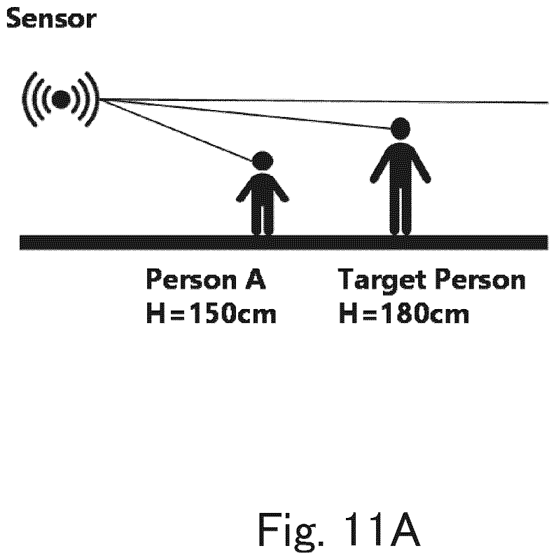

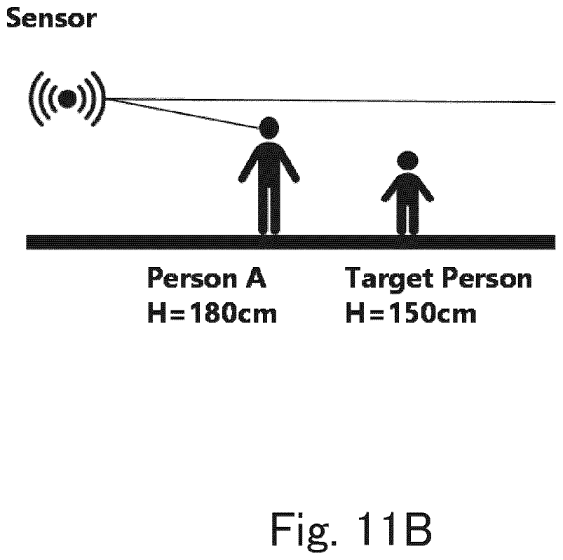

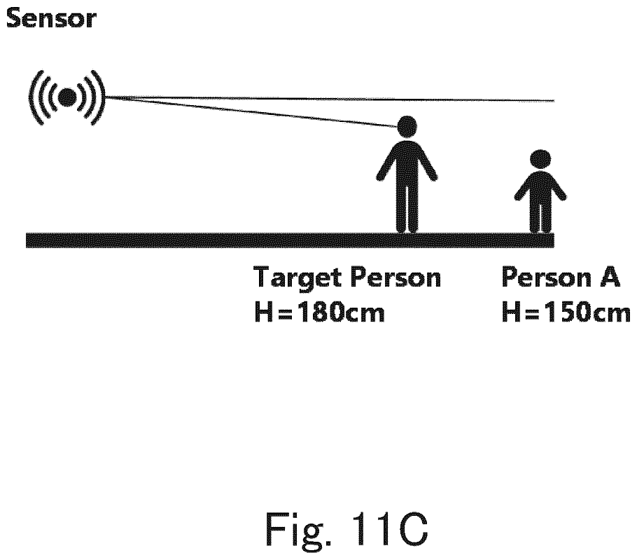

In one embodiment, the tracked object's height may be taken into consideration to accurately determine its tracking reliability. FIGS. 11A-11C depict three different person tracking scenarios where two persons (target person and person A) with different heights and distances from a tracking sensor are tracked according to an embodiment of the present disclosure. In this embodiment, a tracking reliability of the target person is assessed. In FIG. 11A, person A which is nearer to the sensor and shorter than target person, then it is determined that tracking of the target person is still reliable. In FIG. 11B, person A is nearer to the sensor and taller than the target person, then it is determined that tracking of the target person is not reliable. In FIG. 11C, the target person is nearer to the sensor and taller than person A, then it is determined that tracking of the target person is also not reliable.

Returning to FIG. 7, the object apparatus system 701 may additionally determine the height of person A at detection point 702a and the height of person B at detection point 702b. For example, if the height of person A at detection point 702 a is 180 cm and the height of person B at detection point 702 b is 150 cm, even person B is detected within the determination area 704 of detection point 702a, as this is the case, the tracking of person A may still be determined as reliable.

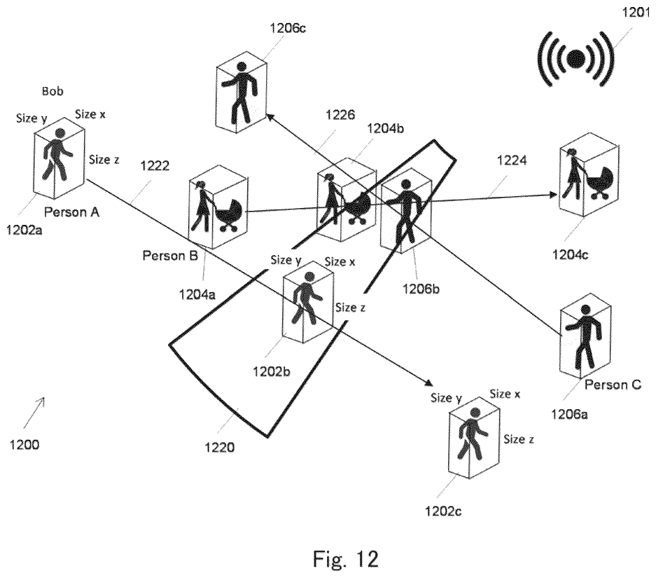

According to the present disclosure, an object tracking sensor may track an object and determine its pathway and potential pathway based on the object size. FIG. 12 depicts a schematic diagram 1200 illustrating an object tracking sub-system 1201 for determining a potential pathway of a person according to various embodiments of the present disclosure. The object tracking sub-system 1201 detects person A with an output size of size (x, y, z) and other two persons (persons B and C with their output size (not shown)) at different locations (illustrated using same person figure blocks) along their pathway (as illustrated using arrows 1222, 1224, 1226) across a time period. In this case, the target person is person A, and the person A tracking reliability is assessed at detection point 1202b with a determination area 1220 around the detection point 1202b. It is determined that person B and person C are also detected by the object tracking sensor 1200 around the same time t or slightly thereafter (e.g., t+1s) within the determination area 1220, and thus person B and person C are identified as potential associates of person A.

The object tracking sensor 1201 may then compare the sizes of person A, and his/her potential associates (person B and person C) when they are detected outside of the determination area 1220, i.e., before they enter the determination area 1220 (e.g., detection points 1202a, 1204a, 1206a where persons A, B and C are detected at a time prior to detection time t) and/or after they move out of the determination area 1220 (e.g., detection points 1202c, 1204c, 1206c where persons A, B and C are detected after the detection time at a time subsequent to detection time t). The respective sizes of person A, person B and person C detected before they enter the determination area 1220 at detection points 1202a, 1204a and 1206a prior to time t and/or after they leave the determination area 1220 at detection points 1202c, 1204c and 1206c subsequent to time t will be compared to determine their potential pathways. In this example, after identifying that the person A tracking may be unreliable based on the detection point 1202b detected at detection time t, the object tracking sub-system 1201 may compare the size of each person detected after he/she leave the determination area 1220, identify a person with a similar size as that of person A (e.g., the person at detection point 1202c) before entering the determination area 1220 (e.g., at detection point 1202a) and concatenate/join person A's previous detection point 1202a detected before time t, the detection point 1202b detected at time t and detection point 1202c detected after time t to form a continuous potential pathway of person A.

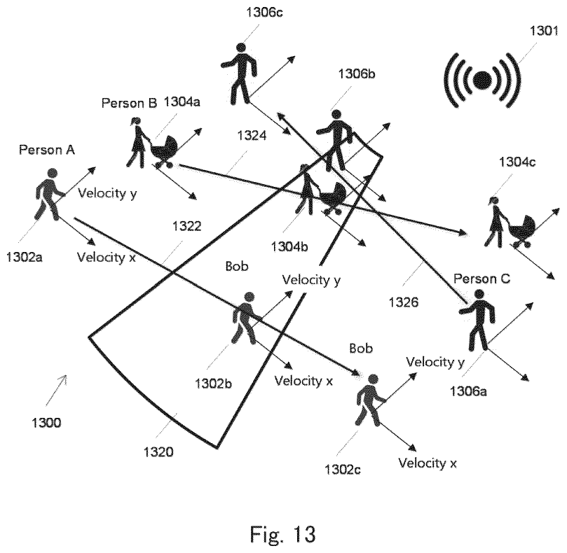

Additionally or alternatively, an object tracking sensor may track an object and determine its pathway and potential pathway based on the velocity or moving speed of the object. FIG. 13 depicts a diagram 1300 illustrating an object tracking sub-system 1301 for determining a potential pathway of a person according to various embodiments of the present disclosure. The object tracking sub-system 1301 detects person A with a velocity (e.g., velocity in x and y axes) and other two persons (persons B and C with their own velocities) at different locations (illustrated using same person figure blocks) along their pathway (as illustrated using arrows 1322, 1324, 1326) across a time period. In this case, the target person is person A, and the person A tracking reliability is assessed at detection point 1302b with a determination area 1320 around the detection point 1302b. It is determined that person B and person C are also detected by the object tracking sensor 1301 around the same time t or slightly thereafter (e.g., t+1s) within the determination area 1320, and thus person B and person C are identified as potential associates of person A.

The object tracking sensor 1301 may then compare the velocity of person A, and his/her potential associates (person B and person C) when they are detected outside of the determination area 1320, i.e., before they enter the determination area 1320 (e.g., detection points 1302a, 1304a, 1306a where persons A, B and C are detected at a time prior to detection time t) and/or after they move out of the determination area 1320 (e.g., detection points 1302c, 1304c, 1306c where persons A, B and C are detected after the detection time at a time subsequent to detection time t). The respective velocities of person A, person B and person C detected before they enter the determination area 1320 at detection points 1302a, 1304a and 1306a prior to time t and/or after they leave the determination area 1320 at detection points 1302c, 1304c and 1306c subsequent to time t will be compared to determine their potential pathways. In this example, after identifying that the person A tracking may be unreliable based on the detection point 1302b detected at detection time t, the object tracking sub-system 1301 may compare the velocity of each person detected after he/she leave the determination area 1320, identify a person with a similar velocity as that of person A (e.g., the person at detection point 1302c) before entering the determination area 1320 (e.g., at detection point 1302a) and concatenate/join its previous detection point 1302a detected before time t, the detection point 1302b detected at time t and detection point 1302c detected after time t to form a continuous potential pathway of person A.

In one embodiment, the object tracking sensor 1201, 1301 may detect person A (target person) and determine its potential pathway based on both his/her size and velocity. For example, after identifying that the target person tracking may be unreliable based on the detection point, the object tracking sensor may compare the size and velocity of each person detected after he/she leave the determination area and generate a reliability score corresponding to how likely is the detected person is the target person, identify a person with the highest reliability score as the target person, and then concatenate/join the previous detection point 1202a, 1302a of the target person detected before time t, the detection point 1202b, 1302b of the target person detected at time t and the detection point associated with the highest reliability score detected after time t to form a continuous potential pathway of the target person. Additionally, the object size parameter and velocity parameter are given weightage and affect the reliability score differently. For example, the size parameter may have a larger weightage than the velocity parameter as the person can change speed and direction, therefore a person with similar size to the target person will generally have higher score than a person with only similar velocity as to the target person.

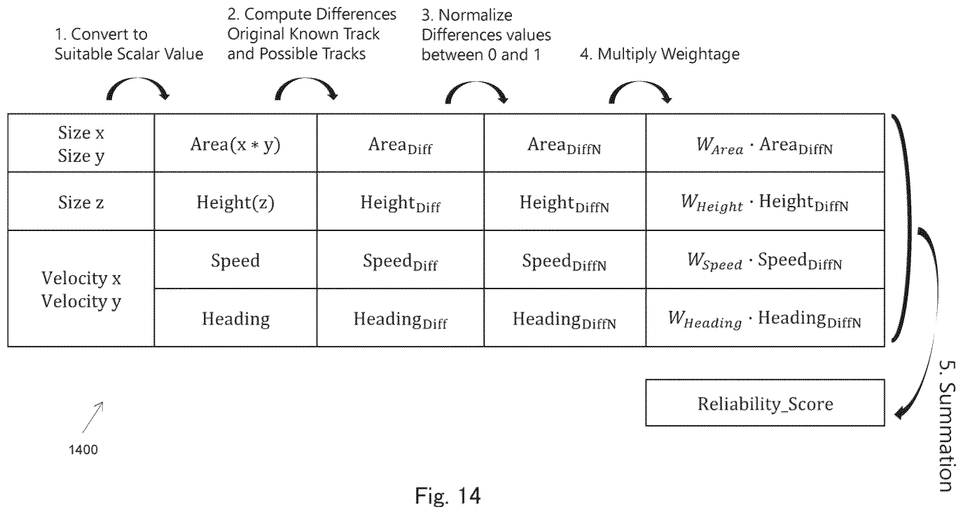

FIG. 14 depict a reliability score calculation table 1400 according to an embodiment of the present disclosure. In this embodiment, five parameters such as a person's size in x, y and z axes (size x, size y and size z) and a person's velocity in x and y axes (velocity x, velocity y), as shown in the first column of the table are used to calculate scalar values of four different contributing factors of the reliability score such as area, height, speed and heading, as illustrated in the second column of the table 1400 in FIG. 14. The differences between the original known track and the possible tracks are then computed and normalized to a value between 0 to 1 as illustrated in the third and fourth columns of the table 1400 in FIG. 14 respectively. Different weightages (Warea, Wheight, Wspeed, Wheading) are applied to different contributing factors and the weighted values are summed up to a reliability score. Such reliability score of each person will be compared and ranked to determine which person has the highest reliability score and may therefore be deemed as the target person.

According to the present disclosure, a potential pathway of the target object can be determined from pathways of objects with more than one association level away from the target object. In various embodiments below, association level indicates a degree of association away from the target object. For example, the target object will have an association level of 0, while an object or pathway with association level of 2 indicates that the object or pathway have a 2^{nd} degree of association with the target object or the pathway of the target object, respectively. Such object and pathway having a 2^{nd} degree of association may also refer to as second level (or level 2) potential associate and level 2 pathway in embodiments below, respectively.

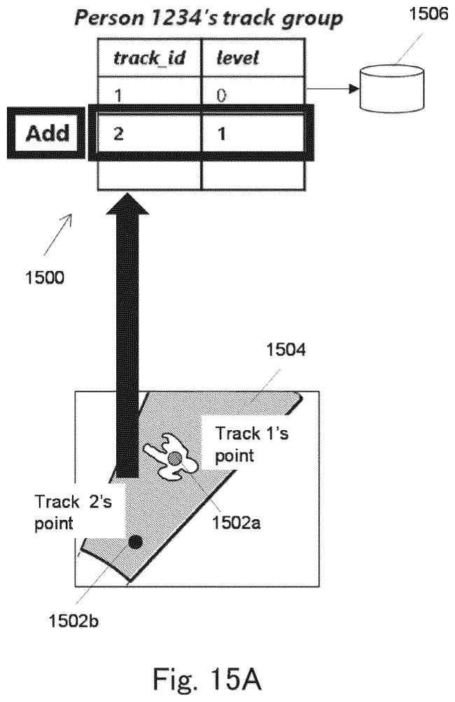

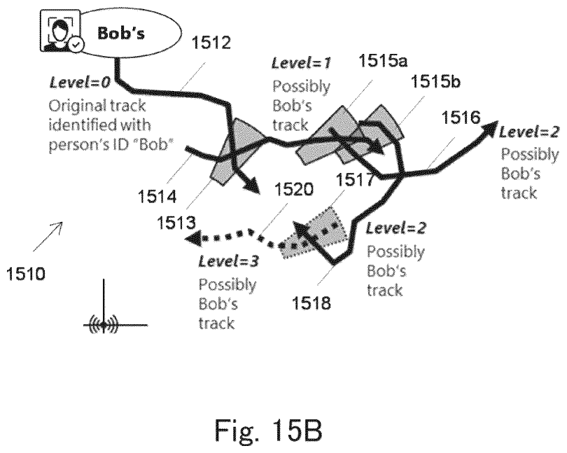

FIG. 15A illustrates an example track group table 1500 of a target object according to an embodiment of the present disclosure. The target object 1502a under track_ID “1″ is tracked. The target object 1502a has an association level of 0. Another object 1502b under track_ID ”2″ is tracked and found to have one detection point in its pathway located within a ground area 1504 of one detection point of the target object's pathway at around a same detection time, thus the object 1502b is identified as a first level potential associate (association level 1) whose pathway is at one point at least very close to the pathway of the target object and directly affects the target object tracking reliability. The pathway of the first level potential associate 1502b is identified as a level 1 pathway.

Similarly, if yet another object (not shown) under track_ID “3” is detected and found to have one detection point of its pathway located within a ground area at one detection point of the pathway of the object 1502b at around a same detection time, it is identified as a second level potential associate (association level 2) whose pathway is at one point at least very close to the pathway of the first level potential associate (association level 1) and directly affects his/her tracking reliability. The pathway of the second level potential associate 1502b is identified as a level 2 pathway. The same can be applied to search for potential associates and pathways of further levels. Such track IDs and association level information will be stored in a database for further retrieval and display of the pathways. In various embodiments below, objects with an association level with the target object and their potential tracks will be placed in a target object's track group.

In one embodiment, the object tracking system will stop tracking for object and track with further levels when the association level reaches the maximum value, e.g., 3 association levels. This is to balance between depth of tracking and computer resources. In particular, increased depth will allow system to track for a longer period of time. The number of tracks can increase exponentially with each association level and more computer resource is needed to process the track with higher association level. Further, tracking object with higher association level may be less meaningful in determination of a target object at level 0. Therefore, by limiting association level, it can limit tracks and computer resource.

FIG. 15B depicts a schematic diagram 1510 illustrating pathways of different association levels according to an embodiment of the present disclosure. The original pathway (track) 1512 identified under person ID “Bob” (target object) is determined. As another pathway 1514 is found to have at least one point located within the ground area 1513 of the original pathway (level 0 pathway) and affect the tracking reliability of the target object, the pathway 1514 is thus identified as a level 1 pathway. Similarly, two other pathways 1516, 1518 are also found to have at least one point located within the ground area 1515a, 1515b of the level 1 pathway and affect the tracking reliability of the first level potential associate, the pathways 1516, 1518 are thus identified as level 2 pathways. Yet another pathway 1520 is found to have at least one point located within the ground area 1517 of the level 2 pathway 1516 and affect the tracking reliability of the second level potential associate, the pathway 1520 is thus identified as a level 3 pathway. According to the present disclosure, all such pathway with association levels 1-3 are determined to be potential Bob's track.

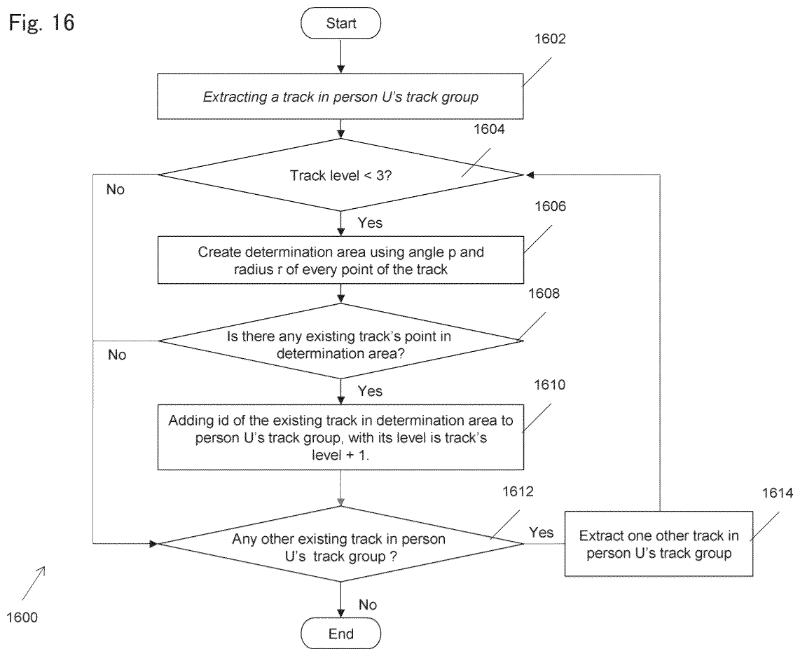

FIG. 16 depicts a flow chart illustrating a process of forming an object's track group according to an embodiment of the present disclosure. In step 1602, a step of extracting a track in person U's (target person's) track group is carried out. In step 1604, it is determined if the track level is lower than 3. If the track level is lower than 3, step 1606 is carried out; otherwise step 1612 is carried out. In step 1606, a step of creating a determination area using angle p and radius r of every point of the track is carried out. In step 1608, it is determined if there is any existing track's point in the determination area. If there is an existing track's point in the determination area, step 1610 is carried out; otherwise step 1612 is carried out. In step 1610, a step of adding ID of the existing track in the determination area to person U's track group is carried out, with a level higher than the track (level of the track +1). In step 1612, it is checked if there is any other existing track in person U's track group. If there is, step 1614 is carried out to extract one other track in person U's track group and then steps 1604-1612 are carried out based on the other track. If there is no other existing track in person U's track group, the process may end.

Although the above embodiments are illustrated using human or person, it is appreciated that the object tracking sensor can track pathways of all moving objects such as vehicles, etc.

In one embodiment, the object tracking sensor may be configured to filter unwanted objects and to be more efficiency in detecting and determining a potential pathway of a human. In such case, the object tracking sensor may be configured to further determine if a size of the object is within a normal human size range or the size of the object is too small or too big to be a human being and/or if a moving speed of the object is within a normal human moving speed limit or the moving speed is too fast to be human.

In the following paragraphs, a second embodiment of the present disclosure where a ground area used for determining a reliability of the current tracking of an object and a potential pathway of the object is configured with reference to a location of the object.

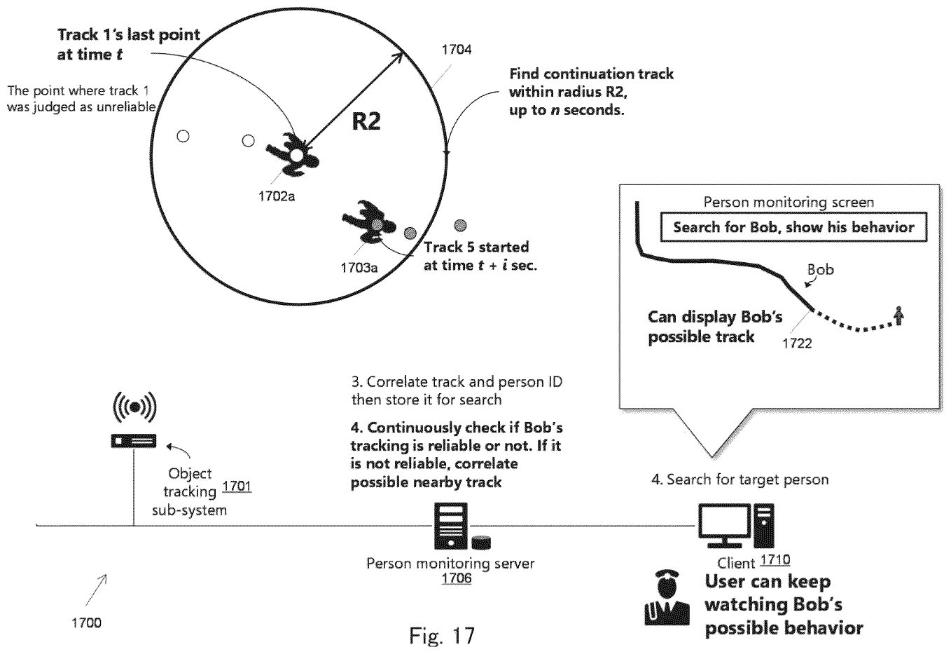

FIG. 17 shows a schematic diagram illustrating a system comprising an object tracking sub-system 1701 for determining a potential pathway of a person according to the second embodiment of the present disclosure. In this embodiment, the object tracking sub-system 1701 is configured to detect all objects moving within its line-of-sight at a regular interval, identify a pathway of each object within its line-of-sight over and determine a potential pathway of an object. As illustrated in FIG. 17, the object tracking sub-system 1701 tracks a person under track ID “1”. However, his/her pathway is lost and the last detection point 1702 a is detected at detection time t. The object tracking sub-system 1701 is then configured to find a continuation pathway by checking whether a detection point of another person was also detected within a determination area 1704 centered around the detection point 1702a. In this example, the determination area 1704 being a circular area extending a fixed ground distance (radius R2) in all directions from the detection point 1702a. The object tracking sensor 1701 detects a pathway under track ID “5” starts at detection point 1703a shortly thereafter at time t+i. The object tracking sub-system 1701 may identify the pathway of the person under track ID “5” as the possible continuation pathway of the person under track ID “1” whose track is lost at time t. Such detection data and their associated ID will then be stored in the database in communication with the person monitoring server 1706. The multiple detection points and potential detection points of the object can then be concatenated/joined according to the chronological order to determine a pathway 1722 of the object in the room and displayed in a client device or server 1710.

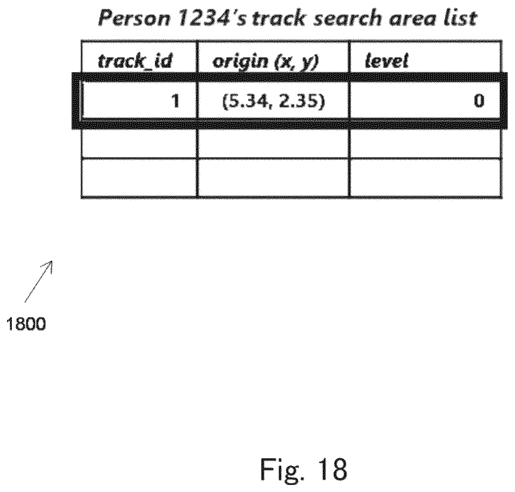

FIG. 18 depicts an example track group table 1800 of a target object according to the second embodiment of the present disclosure. Besides the track ID and its association level and unlike the table in FIG. 15A, the target person search area origin, i.e., the location/detection point where the target subject's track is lost or last detection, and where the determination area is centered, is also tabulated.

This is particularly useful for lost track situation and continuation track discovery as the user will be informed with the last detection point of the person.

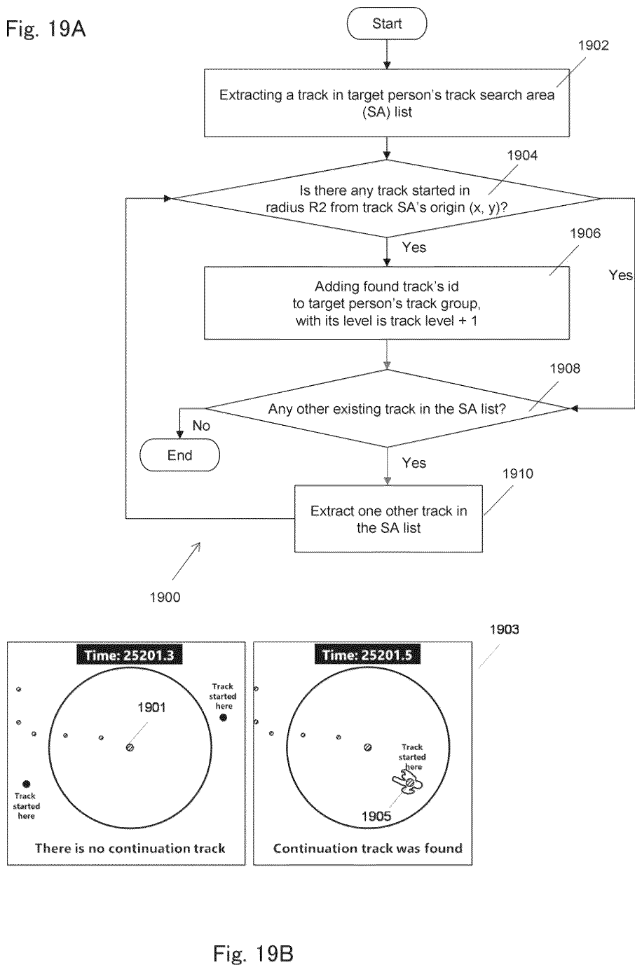

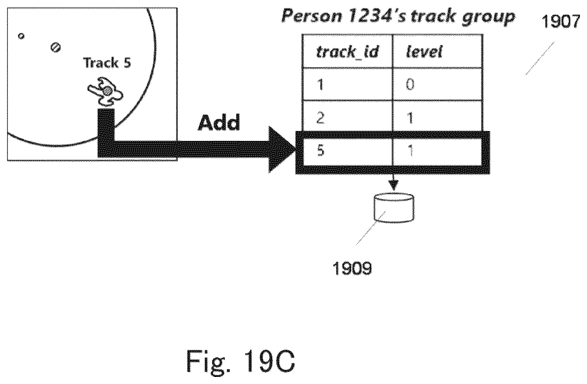

FIGS. 19A-19C depict a flow chart 1900 illustrating a process of forming a target person's track group according to the second embodiment of the present disclosure. In this example, the target person's track is lost in time 25201.3 as shown in block 1903 of FIG. 19B. In step 1902, a step of extracting a track in target person's track search area (SA) list. In step 1904, a step of determining if there is any track started in radius R2 from track SA's origin (x, y) 1901 is carried out. If there is a track started in radius R2 from SA's origin (x, y) 1901, as shown in block 1903 where a new track/person 1905 is detected after the track of the target object is lost at time 25201.5, step 1906 is carried out; otherwise step 1908 is carried out. In step 1906, a step of adding found track's ID to target person's track group with a level higher than the track level (track level+1), as shown in block 1907 where track ID “5” is added with an association level 1. The track IDs and their association levels are then stored in a database 1909. In step 1908, it is checked if there is any other existing track in the SA list. If there is, step 1910 is carried out to extract one other track in the SA list and then steps 1904-1908 are carried out based on the extracted track. If there is no other existing track in the SA list, the process may end.

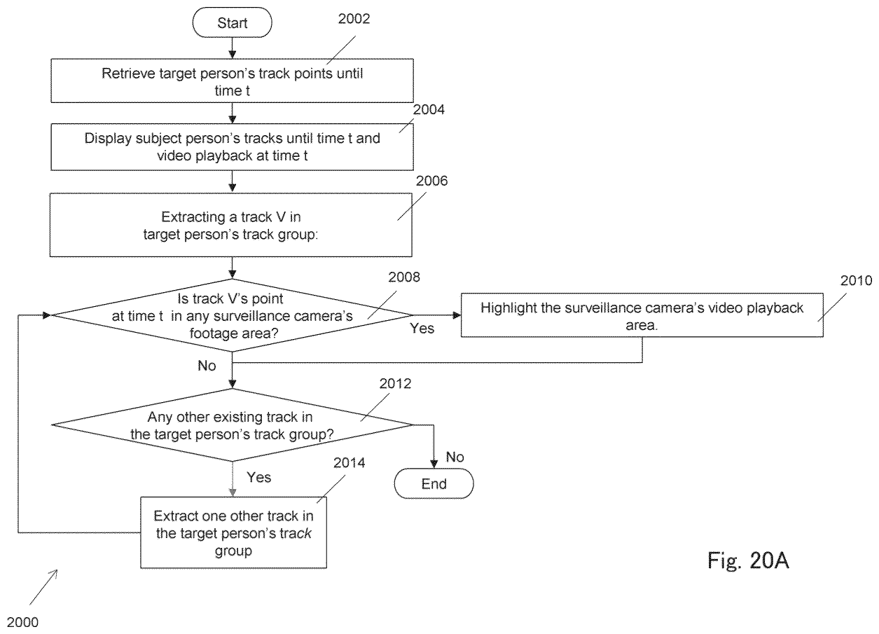

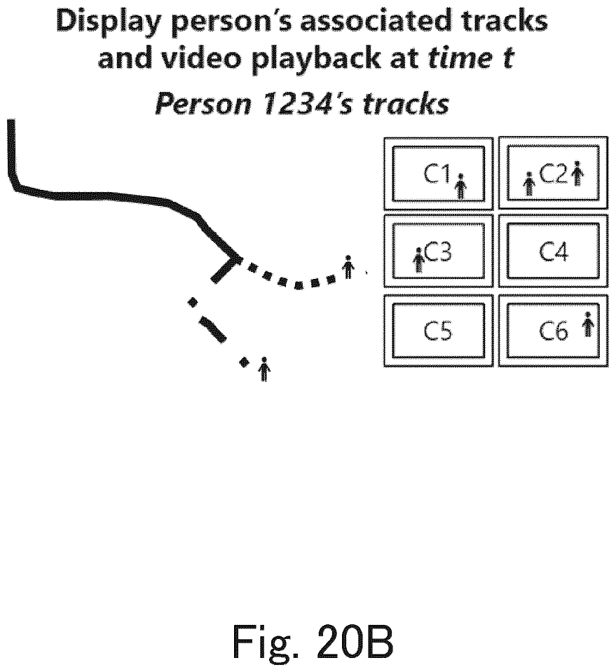

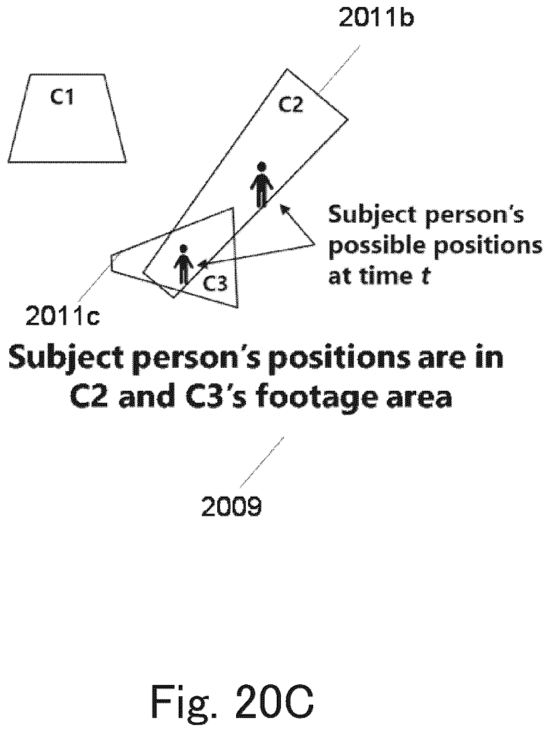

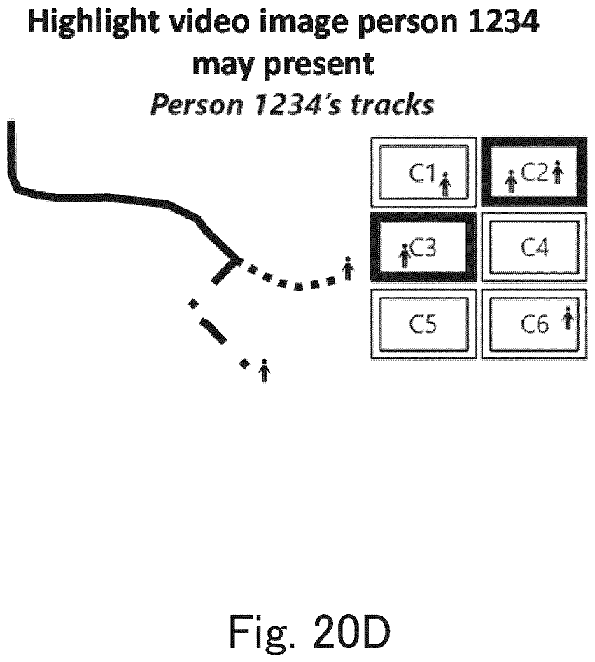

FIGS. 20A-20D depict a flow chart 2000 illustrating a process of displaying a potential pathway of an object under multiple sensors setting according to an embodiment of the present disclosure, where C1-C6 refer to cameras or sensors 1-6. In step 2002, a step of retrieving target point's track points until time t. In step 2004, a step of displaying target person's tracks until time t and video playback at time t. In step 2006, a step of extracting a track V in target person's track group (refer to FIG. 20B). In step 2008, it is determined if the track V's point at time t is any surveillance camera's footage area. For example, as illustrated in block 2009, it is determined that the target person is detected within the line-of-sight 2011b, 2011c of both C2 and C3 at different positions, indicating that there may be two different detections and therefore two potential pathways of the target person. If it is determined that the track V's point at time t is in surveillance camera's footage area, step 2010 is carried out; otherwise step 2012 is carried out. In step 2010, a step of displaying the potential pathways and highlighting the surveillance camera's video playback area (refer to FIG. 20D). In step 2012, a step of determining if there is any other existing track V in the target person's track group. If there is, step 2014 is carried out where one other track in the track group is extracted and steps 2008-2012 are carried out based on the extracted track. If there is no other existing track V in the target person's track group, the process may end.

According to the present disclosure, two different ground area configurations for example, one configured with reference to a location of the object and another one configured with reference to the reference line/plane and position of the object tracking sensor may be used for determining a reliability of the current tracking of an object and a potential pathway of the object.

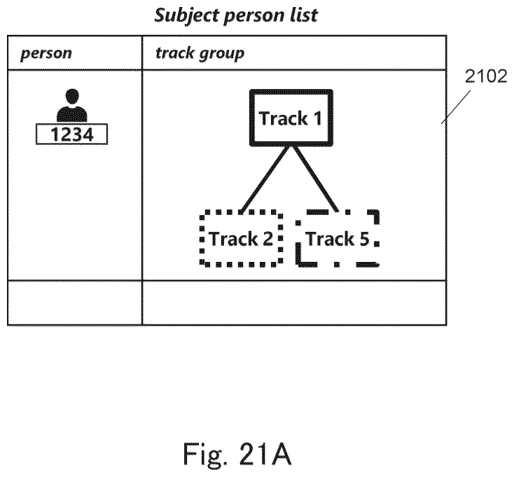

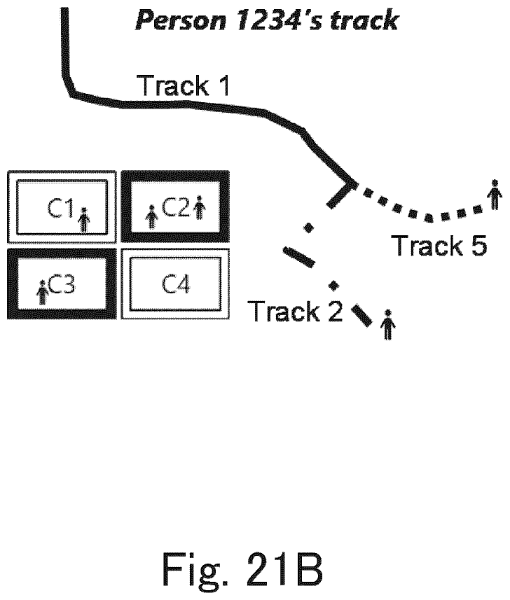

FIG. 21A depicts an example target person's track group table 2102 and the relevant tracks according to an embodiment of the present disclosure. According to the track group table 2102, a target object is detected under Track 1 with high reliability and thus it is identified as the confirmed track at association level 0.

While the object tracking system and person monitoring server is in operation, other track point under different track ID may be detected, and nearby tracks are checked and determined if they are associated tracks of the target persons. In this case, two associated tracks (Track 2 and Track 5) are found and added into track group table at association level 1. In this embodiment, Track 2 may be determined from a rectangular determination area of a detection point of the target person configured in accordance with that discussed in the first embodiment above, and Track 5 may be determined from a circular determination area of a detection point of the target person (could be same or different detection point as that used for determining Track 2) configured in accordance with that discussed in the second embodiment above. When a user requests to display the target person's behaviour and pathway, the confirmed track (Track 1) and both associated Tracks 2 and 5 are displayed, as illustrated in FIG. 21B. The video playback which the target person may appear is also highlighted.

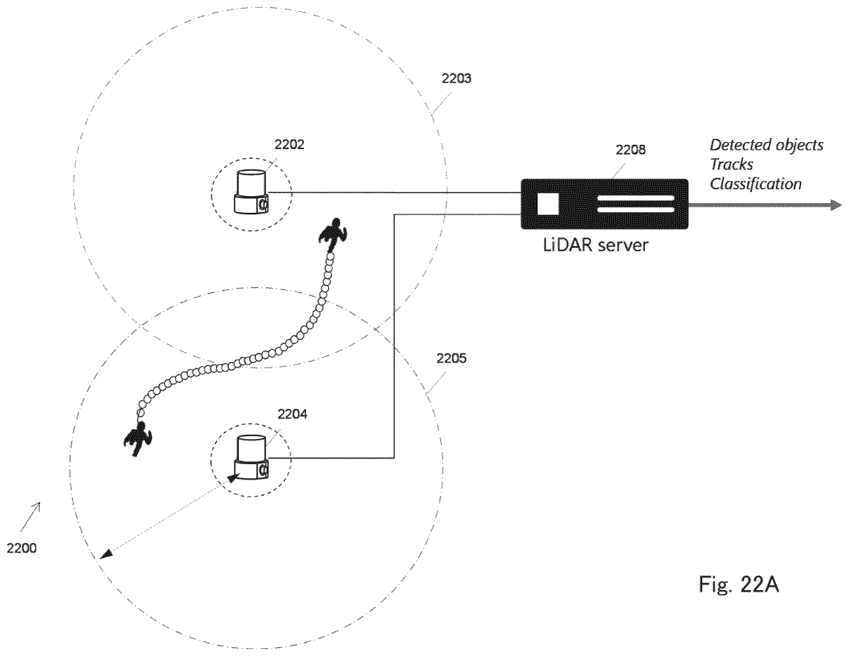

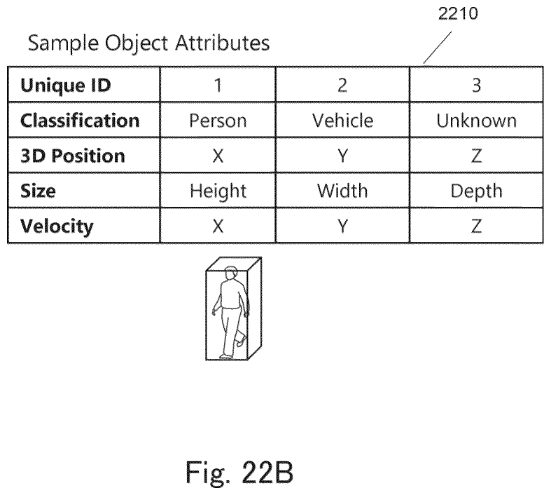

FIGS. 22A and 22B depict a schematic diagram 2200 illustrating a system comprising two object tracking sensors 2202, 2204 for determining a potential pathway of an object 2206 according to an embodiment of the present disclosure. In this embodiment, two LiDAR sensors 2202, 2204 are used in the system to track the object 2006 at different locations. The respective fields of view of the two LiDAR sensors are illustrated in circles 2023 and 2025. The LiDAR sensors 2202, 2204 will transmit their respective detection data to a LiDAR server 2208 to process and compile them based on the sensors'capabilities to determine the object's pathway. The LiDAR server 2208 will then classify the detected object's track based on its attribute and stored the detection data, classification and assigned track ID into a database (not shown) in communication with the LiDAR server 2208. Sample object attributes stored in the database are illustrated in table 2210, where three tracks and objects are identified under three different track IDs classified as person, vehicle and unknown object based on the object attribute.

Unknown object is classified if no classification criteria fit the object attribute.

The three objects have current 3D positions at X, Y, Z and sizes of Height for the person, Width for the vehicle and Depth for the unknown object and moving at X, Y, Z speed respectively.

In an alternative implementation, the object tracking system according to the various embodiments of the present disclosure can be utilized to purely identify potential contacts of a subject (person) by determining nearby tracks. This may be useful for identifying source or spread of an infectious disease or identifying an alliance of a criminal activity.

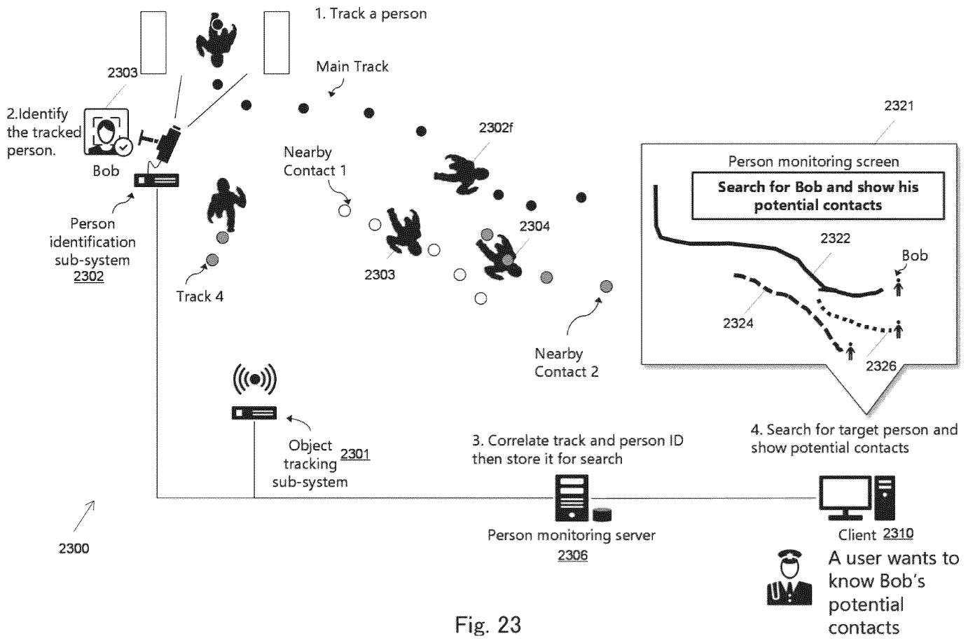

FIG. 23 shows a schematic diagram illustrating a system 2300 an object tracking sub-system 2301 for determining nearby tracks and potential contacts of a target person according to an embodiment of the present disclosure. The operations of person identification and object tracking using person identification sub-system and object tracking sub-system are the same as those described in FIG. 2. In this embodiment, a person identification sub-system 2302 of the system 2300 identifies a target person entering the room based on an image 2303 of the target person and assigned to it track ID “Bob”, and the object tracking sub-system 2301 tracks the target person at regular interval and detects the target person at different locations (detection points) across a time period. a person monitoring server 2306 of the system 2300 may correlate the detection data (e.g., object figure/contour data, location data and time data) under track ID and stored in a database in communication with the person monitoring server 2306 and concatenate/join the detection points according to the chronological order to determine a pathway 2322 of the object in the room and displayed in a client device or server 2310, as shown in block 2321.

Further, each of the detection points (illustrated using black filled dots) along the pathway 2322 of the target person “Bob” (herein referred to as “main track”) is checked whether another person was also detected within a determination area centered around the detection point. Such detection data and their associated IDs relating to other objects may be retrieved from the database of the person monitoring server 2306. For example, at detection point 2302f, it is determined that two other objects are also located at 2303, 2304 within the determination area of the detection point 2302f around the same detection time. The person monitoring server 2306 then identifies that the two other objects as nearby contacts of the target person “Bob”, and their tracks 2324, 2326 as nearby tracks. The track IDs of potential contacts are stored in the database of the person monitoring server 2306, for example, in a track group table of the target person.

On the other hand, the object under Track ID “4” is not detected within the determination area of any of the target person's detection points therefore it is not detected as a nearby contact. Subsequently, if a user request for data relating to Bob's potential contracts for example through a client device 2310, the pathway 2322 of the target person and the two nearby tracks 2324, 2326 may be displayed in the client device 2310, as illustrated in block 2321.

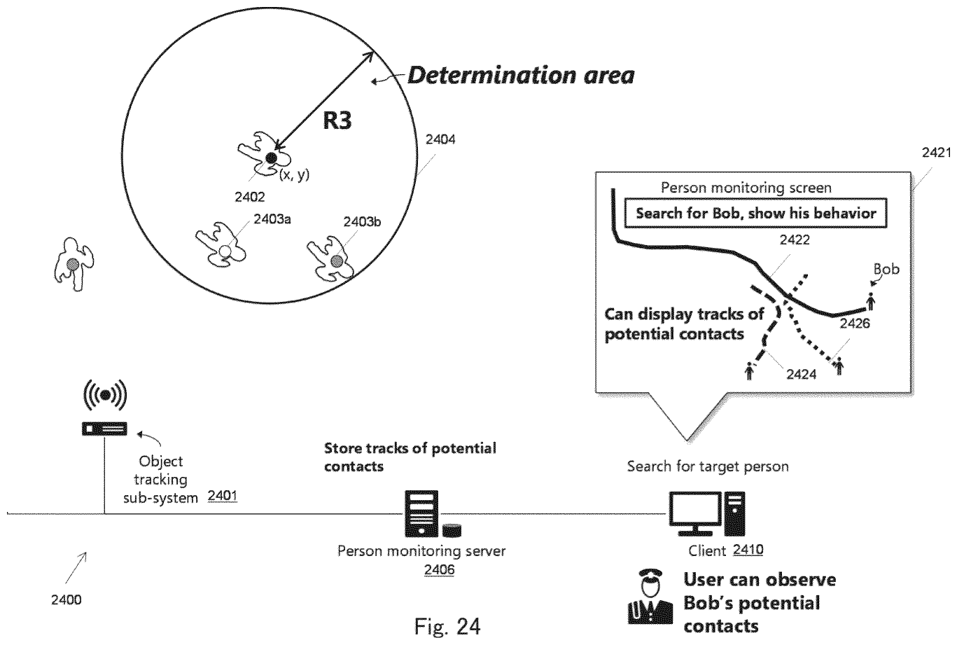

FIG. 24 shows a schematic diagram illustrating a system 2400 comprising an object tracking sub-system 2401 for determining nearby tracks and potential contacts of a target person according to another embodiment of the present disclosure. The object tracking sub-system 2401 detects a target person under track ID “Bob” at different locations (only detection point 2402 is shown) across a time period.

A person monitoring server 2406 of the system 2400 may correlate the detection data (e.g., object figure/contour data, location data and time data) under track ID “Bob” and stored in a database in communication with the person monitoring server 2406 and concatenate/join the detection points according to the chronological order to determine a pathway 2422 of the target object in the room and displayed in a client device or server 2410.

The person monitoring server 2406 may also check each of the detection points of the target person “Bob” whether another person was also detected within a circular determination area 2404 (with a radius of R3) centered around the detection point. The object tracking sub-system 2401 detects two persons 2403 a, 2403b located within the circular determination area 2404 of detection point 2402 and thus identified the two other persons 2423a, 2403b as nearby contacts of the target person “Bob” and their tracks 2424, 2426 as nearby tracks. The track IDs of potential contacts are stored in the database of the person monitoring server 2406, for example, in a track group table of the target person. Subsequently, if a user request for data relating to Bob's potential contracts, the pathway 2422 of the target person and the two nearby tracks 2424, 2426 may be displayed in the client device 2410, as illustrated in block 2421.

It is noted that nearby tracks are an estimation by algorithm and these tracks may sometimes be incorrectly associated. Correction and verification of the potential or nearby tracks may be required. The correction and verification can be achieved by system where the system correct the track IDs, i. e. to by re-identifying the subject at a next facial recognition point. Alternatively, the correction and verification of the potential or nearby tracks can be done by user where the user corrects and verifies the track ID assigned to the potential or nearby tracks.

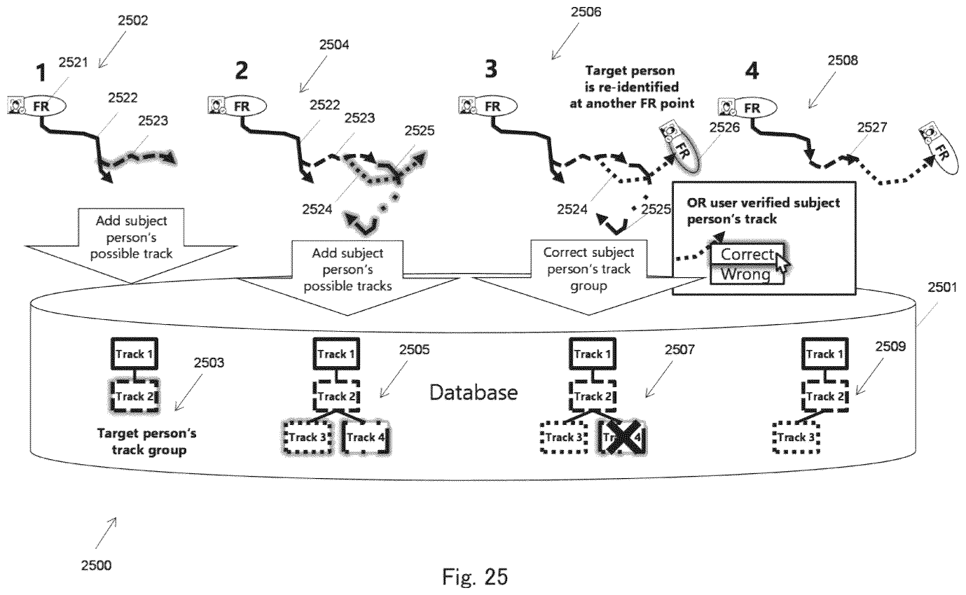

FIG. 25 depicts a flow diagram 2500 illustrating a process of determining a potential pathway of an object and correcting the potential pathway and its data entry in a database (DB) 2501 in communication to a sensor and/or a person monitoring server according an embodiment of the present disclosure. In step 2502, a (target) person is first identified through facial recognition at point 2521, i.e., by comparing data of an image obtained from a sensor against person data stored in the database 2501, matching the image data with data of a person under a person ID and assigning the person ID to the person and image data. The person is then tracked, and their location data detected over a time period are correlated to the person ID and joined into a person's track (Track 1) 2522. The detection data and the main track (Track 1) are then stored in the database 2501. A potential track of the person may also be determined when it is found that the other track (e.g., Track 2) 2523 has at least one point located within the ground area of a point in Track 1, and Track 2 is then identified as level 1 potential track (with one level of association or first degree of association with main track). The information of the potential track (Track 2) 2523, its association level and its presently assigned person ID will then be stored under the target person's track group 2503 in the database 2501.

In step 2504, two level 2 potential tracks 2524, 2525, i.e., Track 3 and Track 4, with 2 levels of association or second degree of association with the main track are identified by finding Track 3 and Track 4 2524, 2525 each has at least one point located within the ground area in Track 2 2523 (level 1 potential track). The information of the two potential tracks (Track 3 and Track 4) 2524, 2525, their association levels and presently assigned person IDs will then be stored under the target person's track group 2505 in the database 2501.

In one example, the verification of track can be performed through system by capturing an image of the object on the potential track at the next facial recognition point 2526. In this case, in step 2506 the object in Track 3 2524 passes by the next facial recognition point 2526 and therefore is verified using sensor, for example, by capturing an image of the object in Track 3 2524 and comparing the image data against the person data in the database 2501 and re-identifying whether the person or the person ID detected in this point 2526 matches with that of the person in Track 1 2522 or that detected in the last facial recognition point 2521. In this case, it is found that the person in Track 3 2524 and in Track 1 2521 matches, therefore the detection data and person ID of Track 4 are removed from the target person's track group 2507.

Alternatively or additionally, especially as Track 3 2524 does not intercept with any facial recognition point 2526, the user can interact with the interface, view the video playback of the track, and perform the verification of the Track 3 2524 himself. The user can either choose “correct” to indicate that it is correct that the object in Track 3 correspond to the object in Track 1, or “wrong” to indicate that the object in Track 3 is not the object in Track 1. In this case, the user chooses “correct”. In step 2508, the system may then link parts of Track 1, Track 2 and Track 3 to form a continuous potential track 2527 of the target person and assign the person ID of the target person to those parts. The information of the final continuous potential track (part of Track 1 +part of Track 2 +part of Track 3) 2527 of the target object, their association levels and their newly assigned person ID will then be updated in the target person's track group 2509 in the database 2501. Optionally, the remaining parts of Track 1, Track 2 and Track 3 that are not linked are not removed from the database, and the system may create a new person ID for each of the remaining parts that are not linked, or link them to one or more other pathways (not shown) to form another continuous potential track of another person (not shown) and assign them with the person ID of the other person. The information and the newly assigned person IDs of those parts will be updated in their respective track groups in the database 2501.

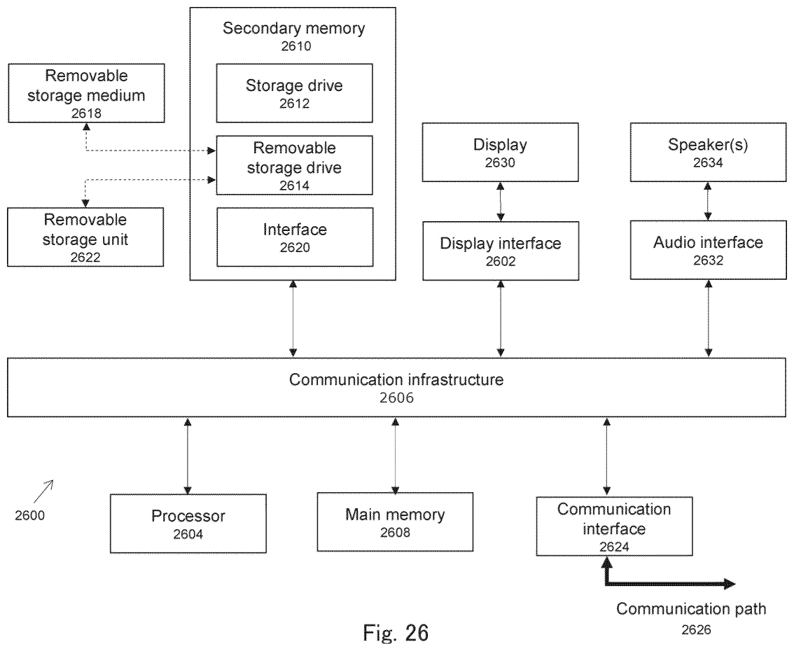

FIG. 26 shows a schematic diagram of an exemplary computing device 2600, hereinafter interchangeably referred to as a computer system 2600, where one or more such computing device 2600 may be used or suitable for use to execute the method in FIG. 5 and implement the apparatus in FIG. 6. The following description of the computing device 2600 is provided by way of example only and is not intended to be limiting.

As shown in FIG. 26, the example computing device 2600 includes a processor 2604 for executing software routines. Although a single processor is shown for the sake of clarity, the computing device 2600 may also include a multi-processor system. The processor 2604 is connected to a communication infrastructure 2606 for communication with other components of the computing device 2600. The communication infrastructure 2206 may include, for example, a communications bus, cross-bar, or network.

The computing device 2600 further includes a main memory 2608, such as a random access memory (RAM), and a secondary memory 2610. The secondary memory 2610 may include, for example, a storage drive 2612, which may be a hard disk drive, a solid state drive or a hybrid drive and/or a removable storage drive 2614, which may include a magnetic tape drive, an optical disk drive, a solid state storage drive (such as a USB flash drive, a flash memory device, a solid state drive or a memory card), or the like. The removable storage drive 2614 reads from and/or writes to a removable storage medium 2618 in a well-known manner. The removable storage medium 2618 may include magnetic tape, optical disk, non-volatile memory storage medium, or the like, which is read by and written to by removable storage drive 2614. As will be appreciated by persons skilled in the relevant art(s), the removable storage medium 2618 includes a computer readable storage medium having stored therein computer executable program code instructions and/or data.

In an alternative implementation, the secondary memory 2610 may additionally or alternatively include other similar means for allowing computer programs or other instructions to be loaded into the computing device 2600. Such means can include, for example, a removable storage unit 2622 and an interface 2620. Examples of a removable storage unit 2622 and interface 2620 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 2622 and interfaces 2620 which allow software and data to be transferred from the removable storage unit 2622 to the computer system 2600.

The computing device 2600 also includes at least one communication interface 2624. The communication interface 2624 allows software and data to be transferred between computing device 2600 and external devices via a communication path 2626. In various embodiments of the disclosures, the communication interface 2624 permits data to be transferred between the computing device 2600 and a data communication network, such as a public data or private data communication network. The communication interface 2624 may be used to exchange data between different computing devices 2600 which such computing devices 2600 form part an interconnected computer network. Examples of a communication interface 2624 can include a modem, a network interface (such as an Ethernet card), a communication port (such as a serial, parallel, printer, GPIB, IEEE 1394, RJ 45, USB), an antenna with associated circuitry and the like. The communication interface 2624 may be wired or may be wireless. Software and data transferred via the communication interface 2624 are in the form of signals which can be electronic, electromagnetic, optical or other signals capable of being received by communication interface 2624. These signals are provided to the communication interface via the communication path 2626.

As shown in FIG. 26, the computing device 2600 further includes a display interface 2602 which performs operations for rendering images to an associated display 2630 and an audio interface 2632 for performing operations for playing audio content via associated speaker(s) 2634.

As used herein, the term “computer program product” may refer, in part, to removable storage medium 2618, removable storage unit 2622, a hard disk installed in storage drive 2612, or a carrier wave carrying software over communication path 2626 (wireless link or cable) to communication interface 2624. Computer readable storage media refers to any non-transitory, non-volatile tangible storage medium that provides recorded instructions and/or data to the computing device 2600 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 2600. Examples of transitory or non-tangible computer readable transmission media that may also participate in the provision of software, application programs, instructions and/or data to the computing device 2600 include radio or infra-red transmission channels as well as a network connection to another computer or networked device, and the Internet or Intranets including e-mail transmissions and information recorded on Websites and the like.

The computer programs (also called computer program code) are stored in main memory 2608 and/or secondary memory 2610. Computer programs can also be received via the communication interface 2624. Such computer programs, when executed, enable the computing device 2600 to perform one or more features of embodiments discussed herein. In various embodiments, the computer programs, when executed, enable the processor 2604 to perform features of the above-described embodiments. Accordingly, such computer programs represent controllers of the computer system 2600.

Software may be stored in a computer program product and loaded into the computing device 2600 using the removable storage drive 2614, the storage drive 2612, or the interface 2620. The computer program product may be a non-transitory computer readable medium. Alternatively, the computer program product may be downloaded to the computer system 2600 over the communications path 2626. The software, when executed by the processor 2604, causes the computing device 2600 to perform the necessary operations to execute the method in FIG. 5 and implement the apparatus in FIG. 6.

It is to be understood that the embodiment of FIG. 26 is presented merely by way of example to explain the operation and structure of the apparatus. Therefore, in some embodiments one or more features of the computing device 2600 may be omitted. Also, in some embodiments, one or more features of the computing device 2600 may be combined together. Additionally, in some embodiments, one or more features of the computing device 2600 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

Part or all of the above example embodiments can be written like the following supplementary note, but not limited to the following.

### Supplementary Note 1

A method for determining a potential pathway of an object, the pathway of the object comprising a plurality of locations at which the object is detected at a corresponding plurality of detection times, the method comprising:
determining, if a first location at which a first object is detected at a detection time along a first pathway of the first object is within a ground distance from a second location at which a second object is detected at or after the detection time along a second pathway of the second object; and
joining at least a part of the first pathway detected before the detection time, at least one of the first location and the second location, and at least a part of the second pathway detected after the detection time to form a continuous potential pathway of the first object in response to the determination of the first location being within the ground distance from the second location.

### Supplementary Note 2

The method of Supplementary Note 1, further comprising:
joining the remaining part of the second pathway, the remaining one of the at least one of the first location and the second location and the remaining part of the first pathway to form a continuous potential pathway of the second object.

### Supplementary Note 3

The method of Supplementary Note 1, wherein the step of determining if the first location at which the first object is detected at the detection time along the first pathway of the first object is within the ground distance from the second location at which the second object is detected at or after the detection time along the second pathway of the second object comprises:
determining if the second location is within a ground area centered around the first location.

### Supplementary Note 4

The method of Supplementary Note 3, wherein the first location is at a distance away from a location of an object tracking apparatus configured to track the first object along the first pathway and the second object along the second pathway and an angular distance from a reference line of the object tracking apparatus, and the ground area centered around the first location spans across an axial distance closer to and away from the location of the object tracking apparatus and an angular distance closer to and away from the reference line of the object tracking apparatus.

### Supplementary Note 5

The method of Supplementary Note 4, further comprising:
determining if the location of the object tracking apparatus is closer to the second location than to the first location, and if a height of the second object is greater than that of the first object, wherein the step of joining the at least the part of the first pathway detected before the detection time, the at least one of the first location and the second location and the at least the part of the second pathway detected after the detection time to form the continuous potential pathway of the first object is carried out in further response to one of (a) the determination of the location of the object tracking apparatus being closer to the second location and the height of the second object being greater than that of the first object and (b) the determination of the location of the object tracking apparatus being closer to the first location and the height of the first object being than that of the second object.

### Supplementary Note 6

The method of Supplementary Note 3, wherein the ground area centered at the first location is a circle having a pre-configured radius with the first location being at a center of the circle.

### Supplementary Note 7

The method of any one of Supplementary Notes 3-6, further comprising:
comparing at least one of (a) a size of the first object at a preceding first location along the first pathway, the preceding first location being a location at which the first object is detected outside the ground area before the detection time, is comparable to that of the second object at a subsequent second location along the second pathway, the subsequent second location being a location at which the second object detected outside of the ground area after the detection time, and (b) a moving speed of the first object along the first pathway at the preceding first location is comparable to that of the second object along the second pathway at the subsequent second location, wherein the step of joining the at least the part of the first pathway detected before the detection time, the at least one of the first location and the second location and the at least the part of the second pathway detected after the detection time to form the continuous potential pathway of the first object is carried out in response to a result of the comparison of the at least one of the sizes and the moving speeds of the first object and the second object.

### Supplementary Note 8

The method of Supplementary Note 7, wherein the step of joining the at least the part of the first pathway detected before the detection time, the at least one of the first location and the second location and the at least the part of the second pathway detected after the detection time to form the continuous potential pathway of the first object is carried out in response to the result of the comparison of both the sizes and the moving speeds of the first object and the second object, the method further comprising:
applying different weightages to the result of the comparison of the sizes and the result of the comparison of the moving speeds to calculate a score; and
determining if the score is higher than that calculated based on a result of another comparison of (a) a size of the first object at a subsequent first location and the size of the first object at the preceding first location and (b) a moving speed of the first object along the first pathway at the subsequent first location and the moving speed of the first object along the first pathway at the preceding first location, the subsequent first location being a location at which the first object is detected outside the ground area after the detection time, wherein the step of joining the at least the part of the first pathway detected before the detection time, the at least one of the first location and the second location and the at least the part of the second pathway detected after the detection time to form the continuous potential pathway of the first object is carried out in response to the determination of the score being higher than that calculated based on the result of the other comparison.

### Supplementary Note 9

The method of Supplementary Note 8, wherein the weightage applied to the result of the determination of the sizes is higher than that applied to the result of the determination of the moving speeds.

### Supplementary Note 10

The method of any one of Supplementary Notes 1-9, further comprising:
determining if at least one of a size of the first object and/or the second object is within a normal human size range, and a moving speed of the first object and/or the second object is lower than a human moving speed limit, wherein the step of joining the at least the part of the first pathway detected before the detection time, the at least one of the first location and the second location and the at least the part of the second pathway detected after the detection time to form the continuous potential pathway of the first object is carried out in further response to the determination of the at least one of the size of the first object and/or the second object being within a normal human size range, and the moving speed of the first object and/or the second object being lower than the human moving speed limit.

### Supplementary Note 11

The method of any one of Supplementary Notes 1-10, further comprising:
displaying both the first pathway and the second pathway on a graphical interface; and
receiving an input in response to an enquiry displayed on the graphical interface to join the at least the part of the first pathway detected before the detection time, the at least one of the first location and the second location, and the at least the part of the second pathway detected after the detection time to form the continuous potential pathway of the first object, wherein the step of joining the at least the part of the first pathway detected before the detection time, the at least one of the first location and the second location and the at least the part of the second pathway detected after the detection time to form the continuous potential pathway of the first object is carried out in response to receiving the input.

### Supplementary Note 12

The method of Supplementary Note 1, further comprising:
generating, by an object tracking apparatus, a pulsed laser across a detection space; and
detecting, by the object tracking apparatus, the pulsed laser reflected by each of the first object and the second object to detect the each of the first object and the second object at a plurality of locations within the detection space and a detection time period, wherein the respective pluralities of locations within the detection space at which the first object and the second object are detected within the respective detection time periods form the first pathway of the first object and the second pathway of the second object.

### Supplementary Note 13

The method of Supplementary Note 12, further comprising:
detecting one of the first object and second object as it enters the detection space by the object tracking apparatus and an appearance of the one of the first object and second object as it enters the detection space by an image capturing apparatus;
assigning an identification of the one of the first object and second object based on data of the appearance; and
associating the identification with corresponding one of the first pathway of the first object and the second pathway of the second object.

### Supplementary Note 14

An apparatus for determining a potential pathway of an object, the pathway comprising a plurality of locations at which the object is detected at a corresponding plurality of detection times, the apparatus comprising:
at least one processor; and
at least one memory including computer program code;
the at least one memory and the computer program code configured to, with at least one processor, cause the server at least to:
determine, if a first location at which a first object is detected at a detection time along a first pathway of the first object is within a ground distance from a second location at which a second object is detected at or after the detection time along a second pathway of the second object; and
join at least a part of the first pathway detected before the detection time, at least one of the first location and the second location, and at least a part of the second pathway detected after the detection time to form a continuous potential pathway of the first object in response to the determination of the first location being within the ground distance from the second location.

### Supplementary Note 15

The apparatus of Supplementary Note 14, wherein the at least one memory and the computer program code configured to, with at least one processor, cause the server at least to further:
join the remaining part of the second pathway, the remaining one of the at least one of the first location and the second location and the remaining part of the first pathway to form a continuous potential pathway of the second object.

### Supplementary Note 16

The apparatus of Supplementary Note 14, wherein the at least one memory and the computer program code configured to, with at least one processor, cause the server at least to further:
determine if the second location is within a ground area centered around the first location.

### Supplementary Note 17

The apparatus of Supplementary Note 16, wherein the first location is at a distance away from a location of an object tracking apparatus configured to track the first object along the first pathway and the second object along the second pathway and an angular distance from a reference line of the object tracking apparatus, and the ground area centered around the first location spans across an axial distance closer to and away from the location of the object tracking apparatus and an angular distance closer to and away from the reference line of the object tracking apparatus.

### Supplementary Note 18

The apparatus of Supplementary Note 17, wherein the at least one memory and the computer program code configured to, with at least one processor, cause the server at least to further:
determine if the location of the object tracking apparatus is closer to the second location than to the first location, and if a height of the second object is greater than that of the first object, wherein the at least one memory and the computer program code configured to, with at least one processor, cause the server at least to:
join the at least the part of the first pathway detected before the detection time, the at least one of the first location and the second location and the at least the part of the second pathway detected after the detection time to form the continuous potential pathway of the first object is carried out in further response to one of (a) the determination of the location of the object tracking apparatus being closer to the second location and the height of the second object being greater than that of the first object and (b) the determination of the location of the object tracking apparatus being closer to the first location and the height of the first object being than that of the second object.

### Supplementary Note 19

The apparatus of Supplementary Note 16, wherein the ground area centered at the first location is a circle having a pre-configured radius with the first location being at a center of the circle.

### Supplementary Note 20

The apparatus of any one of Supplementary Notes 16-19, wherein the at least one memory and the computer program code configured to, with at least one processor, cause the server at least to further:
compare at least one of (a) a size of the first object at a preceding first location along the first pathway, the preceding first location being a location at which the first object is detected outside the ground area before the detection time, is comparable to that of the second object at a subsequent second location along the second pathway, the subsequent second location being a location at which the second object detected outside of the ground area after the detection time, and (b) a moving speed of the first object along the first pathway at the preceding first location is comparable to that of the second object along the second pathway at the subsequent second location, wherein the at least one memory and the computer program code configured to, with at least one processor, cause the server at least to:
join the at least the part of the first pathway detected before the detection time, the at least one of the first location and the second location and the at least the part of the second pathway detected after the detection time to form the continuous potential pathway of the first object is carried out in response to a result of the comparison of the at least one of the sizes and the moving speeds of the first object and the second object.

### Supplementary Note 21

The apparatus of Supplementary Note 20, wherein the at least one memory and the computer program code configured to, with at least one processor, cause the server at least to further:
apply different weightages to the result of the comparison of the sizes and the result of the comparison of the moving speeds to calculate a score; and
determine if the score is higher than that calculated based on a result of another comparison of (a) a size of the first object at a subsequent first location and the size of the first object at the preceding first location and (b) a moving speed of the first object along the first pathway at the subsequent first location and the moving speed of the first object along the first pathway at the preceding first location, the subsequent first location being a location at which the first object is detected outside the ground area after the detection time, wherein the at least one memory and the computer program code configured to, with at least one processor, cause the server at least to:
join the at least the part of the first pathway detected before the detection time, the at least one of the first location and the second location and the at least the part of the second pathway detected after the detection time to form the continuous potential pathway of the first object is carried out in response to the determination of the score being higher than that calculated based on the result of the other comparison.

### Supplementary Note 22

The apparatus of Supplementary Note 21, wherein the at least one memory and the computer program code configured to, with at least one processor, cause the server at least to further:
apply a higher weightage to the result of the determination of the sizes than to the result of the determination of the moving speeds.

### Supplementary Note 23

The apparatus of any one of Supplementary Notes 14-22, wherein the at least one memory and the computer program code configured to, with at least one processor, cause the server at least to further:
determine if at least one of a size of the first object and/or the second object is within a normal human size range, and a moving speed of the first object and/or the second object is lower than a human moving speed limit, wherein the at least one memory and the computer program code configured to, with at least one processor, cause the server at least to:
join the at least the part of the first pathway detected before the detection time, the at least one of the first location and the second location and the at least the part of the second pathway detected after the detection time to form the continuous potential pathway of the first object is carried out in further response to the determination of the at least one of the size of the first object and/or the second object being within a normal human size range, and the moving speed of the first object and/or the second object being lower than the human moving speed limit.

### Supplementary Note 24

The apparatus of any one of Supplementary Notes 14-23, wherein the at least one memory and the computer program code configured to, with at least one processor, cause the server at least to further:
display both the first pathway and the second pathway on a graphical interface; and
receive an input in response to an enquiry displayed on the graphical interface to join the at least the part of the first pathway detected before the detection time, the at least one of the first location and the second location, and the at least the part of the second pathway detected after the detection time to form the continuous potential pathway of the first object, wherein the at least one memory and the computer program code configured to, with at least one processor, cause the server at least to:
join the at least the part of the first pathway detected before the detection time, the at least one of the first location and the second location and the at least the part of the second pathway detected after the detection time to form the continuous potential pathway of the first object is carried out in response to receiving the input.

### Supplementary Note 25

The apparatus of Supplementary Note 14, wherein the at least one memory and the computer program code configured to, with at least one processor, cause the server at least to further:
generate, by an object tracking apparatus, a pulsed laser across a detection space; and
detect, by the object tracking apparatus, the pulsed laser reflected by each of the first object and the second object to detect the each of the first object and the second object at a plurality of locations within the detection space and a detection time period, wherein the respective pluralities of locations within the detection space at which the first object and the second object are detected within the respective detection time periods form the first pathway of the first object and the second pathway of the second object.

### Supplementary Note 26

The apparatus of Supplementary Note 25, wherein the at least one memory and the computer program code configured to, with at least one processor, cause the server at least to further:
detect one of the first object and second object as it enters the detection space by the object tracking apparatus and an appearance of the one of the first object and second object as it enters the detection space by an image capturing apparatus;
assign an identification of the one of the first object and second object based on data of the appearance; and
associate the identification with corresponding one of the first pathway of the first object and the second pathway of the second object detected by the object tracking apparatus.

### Supplementary Note 27

A system for determining a potential pathway of an object comprising the apparatus of any one of Supplementary Notes 14-26, an object tracking apparatus and an imaging capturing apparatus.

This application claims priority based on Singapore Patent Application No. 10202203271V filed on Mar. 30, 2022, and incorporates all of its disclosure herein. AMENDMENT TO CLAIMS

What is claimed is:

1. A method for determining a potential pathway of an object, the pathway of the object comprising a plurality of locations at which the object is detected at a corresponding plurality of detection times, the method comprising:
determining, if a first location at which a first object is detected at a detection time along a first pathway of the first object is within a ground distance from a second location at which a second object is detected at or after the detection time along a second pathway of the second object; and
joining at least a part of the first pathway detected before the detection time, at least one of the first location and the second location, and at least a part of the second pathway detected after the detection time to form a continuous potential pathway of the first object in response to the determination of the first location being within the ground distance from the second location.

2. The method of claim 1, further comprising:
joining the remaining part of the second pathway, the remaining one of the at least one of the first location and the second location and the remaining part of the first pathway to form a continuous potential pathway of the second object.

3. The method of claim 1, wherein the step of determining if the first location at which the first object is detected at the detection time along the first pathway of the first object is within the ground distance from the second location at which the second object is detected at or after the detection time along the second pathway of the second object comprises:
determining if the second location is within a ground area centered around the first location.

4. The method of claim 3, wherein the first location is at a distance away from a location of an object tracking apparatus configured to track the first object along the first pathway and the second object along the second pathway and an angular distance from a reference line of the object tracking apparatus, and the ground area centered around the first location spans across an axial distance closer to and away from the location of the object tracking apparatus and an angular distance closer to and away from the reference line of the object tracking apparatus.

5. The method of claim 4, further comprising:
determining if the location of the object tracking apparatus is closer to the second location than to the first location, and if a height of the second object is greater than that of the first object, wherein the step of joining the at least the part of the first pathway detected before the detection time, the at least one of the first location and the second location and the at least the part of the second pathway detected after the detection time to form the continuous potential pathway of the first object is carried out in further response to one of (a) the determination of the location of the object tracking apparatus being closer to the second location and the height of the second object being greater than that of the first object and (b) the determination of the location of the object tracking apparatus being closer to the first location and the height of the first object being than that of the second object.

6. The method of claim 3, wherein the ground area centered at the first location is a circle having a pre-configured radius with the first location being at a center of the circle.

7. The method of claim 3, further comprising:
comparing at least one of (a) a size of the first object at a preceding first location along the first pathway, the preceding first location being a location at which the first object is detected outside the ground area before the detection time, is comparable to that of the second object at a subsequent second location along the second pathway, the subsequent second location being a location at which the second object detected outside of the ground area after the detection time, and (b) a moving speed of the first object along the first pathway at the preceding first location is comparable to that of the second object along the second pathway at the subsequent second location, wherein the step of joining the at least the part of the first pathway detected before the detection time, the at least one of the first location and the second location and the at least the part of the second pathway detected after the detection time to form the continuous potential pathway of the first object is carried out in response to a result of the comparison of the at least one of the sizes and the moving speeds of the first object and the second object.

8. The method of claim 7, wherein the step of joining the at least the part of the first pathway detected before the detection time, the at least one of the first location and the second location and the at least the part of the second pathway detected after the detection time to form the continuous potential pathway of the first object is carried out in response to the result of the comparison of both the sizes and the moving speeds of the first object and the second object, the method further comprising:
applying different weightages to the result of the comparison of the sizes and the result of the comparison of the moving speeds to calculate a score; and
determining if the score is higher than that calculated based on a result of another comparison of (a) a size of the first object at a subsequent first location and the size of the first object at the preceding first location and (b) a moving speed of the first object along the first pathway at the subsequent first location and the moving speed of the first object along the first pathway at the preceding first location, the subsequent first location being a location at which the first object is detected outside the ground area after the detection time, wherein the step of joining the at least the part of the first pathway detected before the detection time, the at least one of the first location and the second location and the at least the part of the second pathway detected after the detection time to form the continuous potential pathway of the first object is carried out in response to the determination of the score being higher than that calculated based on the result of the other comparison.

9. The method of claim 8, wherein the weightage applied to the result of the determination of the sizes is higher than that applied to the result of the determination of the moving speeds.

10. The method of claim 1, further comprising:
determining if at least one of a size of the first object and/or the second object is within a normal human size range, and a moving speed of the first object and/or the second object is lower than a human moving speed limit, wherein the step of joining the at least the part of the first pathway detected before the detection time, the at least one of the first location and the second location and the at least the part of the second pathway detected after the detection time to form the continuous potential pathway of the first object is carried out in further response to the determination of the at least one of the size of the first object and/or the second object being within a normal human size range, and the moving speed of the first object and/or the second object being lower than the human moving speed limit.

11. The method of claim 1, further comprising:
displaying both the first pathway and the second pathway on a graphical interface; and
receiving an input in response to an enquiry displayed on the graphical interface to join the at least the part of the first pathway detected before the detection time, the at least one of the first location and the second location, and the at least the part of the second pathway detected after the detection time to form the continuous potential pathway of the first object, wherein the step of joining the at least the part of the first pathway detected before the detection time, the at least one of the first location and the second location and the at least the part of the second pathway detected after the detection time to form the continuous potential pathway of the first object is carried out in response to receiving the input.

12. The method of claim 1, further comprising:
generating, by an object tracking apparatus, a pulsed laser across a detection space; and
detecting, by the object tracking apparatus, the pulsed laser reflected by each of the first object and the second object to detect the each of the first object and the second object at a plurality of locations within the detection space and a detection time period, wherein the respective pluralities of locations within the detection space at which the first object and the second object are detected within the respective detection time periods form the first pathway of the first object and the second pathway of the second object.

13. The method of claim 12, further comprising:
detecting one of the first object and second object as it enters the detection space by the object tracking apparatus and an appearance of the one of the first object and second object as it enters the detection space by an image capturing apparatus;
assigning an identification of the one of the first object and second object based on data of the appearance; and
associating the identification with corresponding one of the first pathway of the first object and the second pathway of the second object.

14. An apparatus for determining a potential pathway of an object, the pathway comprising a plurality of locations at which the object is detected at a corresponding plurality of detection times, the apparatus comprising:
at least one processor; and
at least one memory including computer program code;
the at least one memory and the computer program code configured to, with at least one processor, cause the server at least to:
determine, if a first location at which a first object is detected at a detection time along a first pathway of the first object is within a ground distance from a second location at which a second object is detected at or after the detection time along a second pathway of the second object; and
join at least a part of the first pathway detected before the detection time, at least one of the first location and the second location, and at least a part of the second pathway detected after the detection time to form a continuous potential pathway of the first object in response to the determination of the first location being within the ground distance from the second location.

15-27. (canceled)

28. A non-transitory computer-readable medium storing a program for causing an apparatus for determining a potential pathway of an object to perform processes, the pathway of the object comprising a plurality of locations at which the object is detected at a corresponding plurality of detection times, the processes comprising:
determining, if a first location at which a first object is detected at a detection time along a first pathway of the first object is within a ground distance from a second location at which a second object is detected at or after the detection time along a second pathway of the second object; and
joining at least a part of the first pathway detected before the detection time, at least one of the first location and the second location, and at least a part of the second pathway detected after the detection time to form a continuous potential pathway of the first object in response to the determination of the first location being within the ground distance from the second location.
